(19) United States
(12) Patent Application Publication
(10) Pub. No.: US 2020/0375127 A1
(43) Pub. Date: Dec. 3, 2020

(54) SOILLESS PLANT GROWING SYSTEMS

(71) Applicant: Fogworks LLC, Westlake, OH (US)

(72) Inventor: Zachary Brian Thoma, Westlake, OH (US)

(21) Appl. No.: 16/997,344

(22) Filed: Aug. 19, 2020

Related U.S. Application Data
(63) Continuation-in-part of application No. 15/042,475, filed on Feb. 12, 2016, now abandoned.
(60) Provisional application No. 62/117,484, filed on Feb. 18, 2015.

(51) Int. Cl. A01G 31/06; A01G 9/24

(52) U.S. Cl. CPC A01G 31/06; A01G 9/247

(57) ABSTRACT

A soilless plant growing system is described. The system includes a receptacle for retaining airborne water droplets, fog or mist, a plant supporting tray positioned within or upon the receptacle, a water reservoir, and a water droplet, fog or water mist generator that directs such to plants in the tray. The water reservoir includes provisions to automatically supply water to the generator. The receptacle may include water recirculating provisions to direct condensed water droplets, fog or mist to the generator.

### CROSS REFERENCES TO RELATED APPLICATIONS

This application claims priority from U.S. nonprovisional application Ser. No. 15/042,475 filed Feb. 12, 2016, which claims priority on U.S. provisional application Ser. No. 62/117,484 filed on Feb. 18, 2015.

### FIELD

The present subject matter relates to systems for growing plants without soil, and particularly to aeroponic systems.

### BACKGROUND

Hydroponic plant growing systems are well known in the art. Such systems typically support plants above a source of water such that roots from the plants are in contact with the water. Although satisfactory in many regards, such systems require monitoring of the water level and/or periodic refilling of water so that the plant roots remain in contact with the water. In addition, hydroponic systems require significant space and typically have a large “footprint” as such systems are usually horizontally arranged to establish contact between plants and the water surface. Furthermore, using a common water medium can lead to transmission of water-based diseases or pathogens between plants.

Certain plant growing systems such as aeroponic systems employ fog or water mist generators that direct fog or mist to plant roots in a closed chamber or region. Such systems are useful, however humidity controls are typically needed in order to avoid excessive humidity for prolonged time periods. Excessive humidity can lead to mold, disease, or other undesirable consequences. Humidity controls increase cost and complexity of plant growing systems and thus may not be desirable.

Closed plant growing systems are typically used to promote water delivery or availability to plant roots. However, such closed systems typically limit water delivery or availability to other regions of plants such as leaves and shoots. Such closed systems can also interfere with plant exposure to ambient light, thus requiring external lights for the system. Closed systems may also be undesirable as such systems may require controls to administer carbon dioxide, fresh air, or other gases. As will be appreciated, such controls increase complexity and costs of the resulting system.

Accordingly, a need remains for a soilless system for growing plants which does not require water level monitoring or frequent water refilling. In addition, a need exists for a low cost soilless growing system which is free of humidity sensors and humidity controls. Furthermore, a need exists for a soilless growing system in which plant leaves and shoots are freely exposed to ambient air and light and not confined within a closed system, thereby avoiding costly gas administration provisions and controls. Exposing plant shoots and leaves to ambient air and light will also reduce the ability of pathogens to grow on the plants by eliminating the conditions in which the pathogens thrive.

### SUMMARY

The difficulties and drawbacks associated with previous approaches are addressed in the present subject matter as follows.

In one aspect, the present subject matter provides a plant propagator system comprising a rack unit, and a plurality of modular plant propagators. The rack unit includes a support frame defining a plurality of receiving regions. Each receiving region is configured to receive a modular plant propagator. Each of the plurality of modular plant propagators is configured to fit within a corresponding receiving region and includes (i) a receptacle, and (ii) at least one fog production chamber in flow communication with the receptacle.

In another aspect, the present subject matter provides a networked system of plant growing systems. The networked system comprises a registration and control component having data storage provisions and communication provisions. The networked system also comprises at least one mobile electronic device including data storage provisions, communication provisions, and user interface provisions. The networked system additionally comprises at least one plant growing system including a receptacle, fog production provisions, and communication provisions. The at least one plant growing system is capable of communicating with the registration and control component and/or the at least one mobile electronic device.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a perspective view of an embodiment of a plant growing system in accordance with the present subject matter.

FIG. 2 is a perspective cross sectional view taken along a length dimension of the system depicted in FIG. 1.

FIG. 3 is an elevational view of the cross section of FIG. 2 illustrating additional aspects of the plant growing system.

FIG. 4 is a perspective view of the plant growing system of FIG. 1 showing removal of a water reservoir from the system.

FIG. 5 is an exploded view of the plant growing system of FIG. 1 showing additional aspects and assembly of the system.

FIG. 6 schematically illustrates an embodiment of a modular or inter-connecting assembly used in certain versions of the plant growing system of the present subject matter.

FIG. 7 schematically illustrates an embodiment of a plant support system used in certain versions of the plant growing system of the present subject matter.

FIG. 8 depicts an embodiment of an indication panel, plant lighting, sensors, heaters, and timers used in particular versions of the plant growing system of the present subject matter.

FIG. 9A shows a representative mobile device in wireless communication with the growing system. FIG. 9B also shows a representative indicator of fog output.

FIG. 10 illustrates a nested support configuration used in certain embodiments of the growing system in accordance with the present subject matter.

FIG. 11 illustrates interchangeable lids or trays used in certain embodiments of the growing system in accordance with the present subject matter.

FIG. 12 illustrates an embodiment of a water filtration system and a nutrient cartridge used in a growing system in accordance with the present subject matter.

FIG. 13 illustrates an embodiment of a seed starting mat used in association with a tray in accordance with the present subject matter.

FIG. 14 illustrates an embodiment of a modular commercial plant propagator in accordance with the present subject matter.

FIG. 15 illustrates an embodiment of a rack with a plurality of modular plant propagators.

FIG. 16 illustrates another embodiment of a fog production chamber with a fog handling system in accordance with the present subject matter.

FIG. 17 illustrates another embodiment of a plant growing system in accordance with the present subject matter.

FIG. 18 illustrates another embodiment of a plant growing system in accordance with the present subject matter.

FIG. 19 illustrates another embodiment of a plant growing system in accordance with the present subject matter.

FIGS. 20-22 illustrate embodiments of a decorative planter growing system in accordance with the present subject matter.

FIG. 23 is a schematic illustration of an embodiment of a networked system of growing systems in accordance with the present subject matter.

FIG. 24 is a flowchart of an embodiment of a method for improving plant growth from cuttings in accordance with the present subject matter.

FIG. 25 is a flowchart of an embodiment of a method for improving seed growth in accordance with the present subject matter.

FIG. 26 is a flowchart of an embodiment of a method for improving species growth in accordance with the present subject matter.

### DETAILED DESCRIPTION OF THE EMBODIMENTS

The plant growing systems of the present subject matter generally comprise a receptacle and tray for supporting one or more plants such that lower plant regions or plant portions are exposed to water droplets, fog or mist generally retained in the receptacle. The systems also comprise a generator for producing water droplets, fog or mist which are directed to the receptacle and plants supported therein. In many versions of the present subject matter, the generator is in the form of a piezo-electric element that is submerged in water in a fog production chamber. The systems additionally comprise a water reservoir which delivers water to the generator, and in many versions retains a relatively large quantity of water sufficient for operation of the system over a time period associated with desired plant growth. In particular versions of the systems, the system and in particular the receptacle includes water-recirculating provisions which direct condensed water droplets, fog or mist from the receptacle to the fog production chamber. Additional aspects and components of the systems include, but are not limited to, fan assemblies for directing the water droplets, fog or mist from the fog production chamber to the receptacle and one or more vents for directing water droplets, fog or mist in the receptacle and under the tray to region(s) above the tray.

In certain embodiments, the various plant growing systems of the present subject matter are preferably free of covers, lids, or other like members extending over the tray and/or receptacle. Avoiding the use of such components promotes exposure of upper regions or portions of plants supported in the tray to ambient air and light. Furthermore, avoiding the use of such components avoids the problems associated with closed growing systems. In addition, avoiding such components reduces cost and complexity of the resulting system. However, in other embodiments the present subject matter includes growing systems with covers, lids, or other members.

In certain embodiments, the various plant growing systems of the present subject matter are free of sensors and associated controls relating to maintaining prescribed temperatures, humidity levels, and/or gas composition for plants in the system. Avoiding the use of such sensors and controls, reduces the cost and complexity of the resulting system. However, as described herein, in other embodiments growing systems include sensors.

In one embodiment, the present subject matter provides a soilless plant growing system comprising a receptacle having a bottom wall and one or more sidewalls extending upward from the bottom wall to a distal edge defining a receptacle open face. The system also comprises a tray sized and shaped to be positioned with the receptacle. The tray defines an underside and an oppositely directed topside. The tray also defines a plurality of openings extending between the underside and the top side. The system also comprises a fog production chamber in flow communication with the receptacle. The system additionally comprises a water reservoir in flow communication with the fog production chamber and including gravity feed provisions for enabling water flow from the reservoir to the fog production chamber, and maintaining a predetermined water level in the fog production chamber. The system also comprises a piezo-electric element disposed in the fog production chamber and at a height below the water level in the fog production chamber. The piezo-electric element is configured to generate water droplets from water in the chamber upon application of electric power to the piezo-electric element, wherein the water droplets migrate from the fog production chamber to the receptacle.

In another embodiment, the present subject matter provides a soilless plant growing system comprising a receptacle for retaining airborne water droplets. The receptacle includes a bottom wall, a tray positioned above the bottom wall and defining a plurality of openings for holding plants. The receptacle is free of covers or lids extending over the tray. The system also comprises a fog production chamber in flow communication with the receptacle. The system also comprises a water reservoir in flow communication with the fog production chamber for supplying water to the fog production chamber. The water reservoir includes a spring biased outlet configured to maintain a predetermined water level in the fog production chamber. The system additionally comprises a piezo-electric element disposed in the fog production chamber for producing airborne water droplets. And, the system comprises controls for adjusting operation of the piezo-electric element to thereby vary production of the airborne water droplets.

In yet another embodiment, the present subject matter provides a plant growing system comprising a receptacle defining a sloping bottom wall, a plurality of sidewalls extending upwardly from the bottom wall, and an open top face. The system also comprises a fog production chamber in flow communication with the receptacle. The system also comprises a piezo-electric element disposed in the fog production chamber. The piezo-electric element serves to generate water droplets, fog or mist upon submerging in water and application of electric power thereto. The system also comprises a water reservoir including (i) a housing for retaining a supply of water and (ii) gravity feed provisions configured to deliver water to the fog production chamber and maintain a predetermined water level in the fog production chamber. The system also comprises a tray disposed on the receptacle and extending over the top face of the receptacle, the tray defining a plurality of openings for holding plants. The system is free of covers, lids, or members extending over the tray.

Details as to the components of the present subject matter systems, operation and use of the systems are as follows. In many of the descriptions herein, references to “horizontal,” “vertical,” and/or “sloping” or “inclined” are made. It will be understood that these references and others are with regard to the growing system in its use position such as placed upon a generally flat and horizontal table or shelf.

### Receptacles and Trays

In many embodiments, the various systems utilize a receptacle having a bottom wall and one or more sidewalls extending upward from the bottom wall to define a generally continuous receptacle distal edge and generally open receptacle top face. The receptacle can be in a variety of different shapes, however a square or rectangular shape has been found useful. The sidewalls are typically vertical or substantially so and extend upward and around the periphery of the bottom wall. The receptacle can include one or more legs or support members upon which the receptacle is positioned. Again, the present subject matter includes a wide array of configurations for the receptacle.

The tray is sized and shaped to be positioned within the receptacle or enclosure or be supported across the open face of the receptacle. The tray defines an under side and an oppositely directed top side. The tray also defines one or more openings extending through the tray between the under side and the top side. The openings are configured and arranged for supporting one or more plants in each opening. In many embodiments, the tray includes any number of openings such as from 1 to about 100 or more. Typically, the openings are uniformly arranged and generally equally distant from one another across a top side of the tray. However, the present subject matter includes trays having nonuniform arrangements of openings and/or unequal distances between openings. In particular embodiments, the tray can include a lip or receiving region configured to fittingly engage the distal edge of the sidewalls of the receptacle. A fitting engagement promotes retention of air-borne water droplets, fog, or mist in the interior region of the receptacle defined between the underside of the tray, the receptacle bottom wall, and the sidewalls.

As previously noted, openings in the tray serve to support one or more plants. The one or more plants are positioned in the openings such that the lower region of the plant, e.g., its roots, extends downward into the receptacle for contact with water droplets, fog, or mist. The upper region of the plant, e.g., leaves and shoots, is directed upward from the topside of the tray. One or more inserts having a similar size and shape as the openings can be inserted in respective openings and assist in supporting plants. For example, foam material or rubber material having a circular shape with a slit or aperture extending through the material can be used as inserts by placing such in tray openings and then inserting plants therein, or vice versa.

In particular embodiments, the tray also includes at least one vent extending through the tray and providing air flow communication between regions along the underside and topside of the tray. The one or more vents are configured for directing airborne water droplets, fog, or mist from along the underside of the tray to a region along the topside of the tray. The one or more vents serve to promote transport of water droplets, fog, or mist to region(s) of plants extending above the tray such as leaves and shoots.

The present subject matter includes collections of receptacles used with one or more trays, and/or collections of trays used with one or more receptacles. The receptacles and trays can be formed from a variety of materials however, plastics are preferred for many applications.

### Generator and Chamber for Producing Water Droplets, Fog, or Mist

The present subject matter plant growing systems utilize one or more generator(s) for producing airborne water droplets, fog, or mist which is directed into the receptacle. In many embodiments, the generator is in the form of a piezo-electric transducer or element that is submerged in water. Upon application of electric power to the piezo-electric element, the element vibrates and causes generation of water droplets, fog, or mist from the water surface in a region generally above the submerged element.

Typically, a wide assortment of generator(s) can be used so long as the average size of airborne water droplets, fog, or mist produced by the generator is within a range of from about 1 micron to about 500 microns, with many applications using a size of from 1 to 50 microns.

As noted, piezo-electric transducers can be used to generate such controlled sizes of water droplets, fog, or mist. Typically, such piezo-electric elements are submerged in water at a depth of approximately 1.0 to 1.5 inches and powered to thereby vibrate at a frequency within a range of from about 1 to 10 megahertz, and in many applications at about 4 to 5 megahertz. Although piezo-electric transducers or elements are preferred for many versions of the present subject matter systems, it will be appreciated that the systems can also use other types of generators for producing water droplets, fog, or mist.

Many versions of the present subject matter utilize a fog production chamber which is in flow communication with the receptacle. Thus, upon generation of water droplets, fog, or mist in the chamber, the water droplets, fog, or mist migrates or is actively directed or otherwise transported to the receptacle for contacting plants. The fog production chamber in many embodiments is configured to retain a quantity of water, within which the water droplet, fog, or mist generator is submerged; and an air space above the water level.

In particular versions of the present subject matter, the fog production chamber is incorporated into the receptacle. For example, the fog production chamber may be located within the receptacle and share one or more walls or regions of walls with the receptacle such as portion(s) of the bottom wall and/or portion(s) of the sidewall(s). Incorporating the fog production chamber within or as part of the receptacle eliminates conduits or other water transfer provisions otherwise needed between such components.

The water droplet, fog, or mist generator(s) can include provisions or controls for selectively varying the rate of droplet, fog, or mist production, and/or the size of the water droplets. Such provisions are typically in the form of electronic controls such as a potentiometer which vary or otherwise modify the electric power or its characteristics to the piezo-electric transducer or element.

### Water Reservoir

The present subject matter plant growing systems also utilize a water reservoir that is configured to automatically provide water to the generator(s) and maintain a predetermined water level in the fog production chamber. In many embodiments, the water reservoir is large enough to store a sufficient amount of water for typical operation of the generator(s) over a time period of from about 1 week up to a month or longer. Representative water volumes for the reservoir range from about 0.5 gallon to about 5 gallons. However, it will be appreciated that the present subject matter includes water reservoir sizes larger or smaller than these representative sizes.

In certain embodiments, the water reservoir includes gravity feed provisions for enabling water flow from the reservoir to the fog production chamber. Generally, such gravity feed provisions automatically dispense water to an outlet or other receiving region based upon the water head, height, or pressure in the reservoir. In certain embodiments the gravity feed provisions utilize a spring biased outlet in which the water head, height, or pressure counters a spring force which results in opening of the outlet to allow water exit from the reservoir. It will be understood that the present subject matter includes a wide array of gravity feed provisions and is not limited to the representative embodiment described herein.

The reservoir of the plant growing systems of the present subject matter stores, retains, and administers water to the system in an automatic fashion. User attention such as frequent refilling and/or monitoring of water level in the reservoir is not needed. In certain embodiments, the reservoir is typically large enough to store a sufficient quantity of water to last the entire time period associated with growth of the plants. In many applications, the reservoir is large enough to hold a quantity of water sufficient for one week of operation of the system. Thus, for plant cutting(s) requiring about two weeks to reach a desired growth, the reservoir is filled only once. The reservoir is typically filled with pure water or substantially pure water such as tap water available from most residential sources. The reservoir may also be used with nutrient enriched water or other aqueous liquids.

### Fan Assembly

Many embodiments of the present subject matter also include a fan assembly for directing water droplets, fog or mist produced in the fog production chamber to the receptacle. The fan assembly is typically electrically powered. The fan assembly can be configured in the system such that the fan draws ambient air from outside the receptacle, into the fog production chamber and specifically into the air space above water in the chamber, and then into the receptacle. The resulting flowing air stream transports airborne water droplets, fog or mist in the chamber into the receptacle. The previously noted vents in the tray can serve as outlets for discharging air and water droplets, fog, or mist from the interior of the receptacle to outside, i.e., regions external to the receptacle. Controls or other provisions can be provided to vary fan operation such as fan speed.

### Water-Recirculation

Certain versions of the present subject matter plant growing systems utilize water-recirculation provisions. In particular embodiments, a sloping or downwardly directed receptacle bottom wall is provided that directs condensed water from water droplets, fog, or mist in the receptacle toward the fog production chamber or inlet thereto. The growing systems can include one or more openings or liquid ports for transporting water in the receptacle to the fog production chamber. These openings or liquid ports are in communication with the fog production chamber. Typically, the port(s) is located at a bottom-most region of the sloping bottom wall of the receptacle.

### Fail-Safe Provisions

One or more fail-safe provisions are also utilized in many versions of the present subject matter. For example, control provisions can be provided that prevent operation of the generator, e.g., the piezo-electric element, if a level of water in the reservoir is less than a predetermined minimum water level. Alternatively or in addition, such control provisions can be configured to limit operation of the piezo-electric element if a level of water in the fog production chamber is less than a predetermined minimum water level.

One or more alarms and/or indicators can be provided which provide audible and/or visual indication of such water level condition(s) existing. For example, light emitting element(s) can be provided that emit light if such water levels occur. In certain versions of the present subject matter, the light emitting element(s) can be configured to emit a green light when the noted water level(s) are above or greater than the mentioned predetermined minimum water level(s). The light emitting element(s) can also be configured to emit a red light when the water level(s) are below or less than the noted predetermined minimum water level(s). The present subject matter systems are not limited to these aspects and include a wide array of other operating and/or visual indicators.

In particular embodiments, the control provisions that limit operation of the piezo-electric element can be configured to preclude operation if a water level in the reservoir is less than a predetermined volume of water, which for example can be based upon the total volumetric capacity of the reservoir. For example, the predetermined volume at which operation of the piezo-electric element is precluded can be 30% of the total capacity of the reservoir. Alternatively, the predetermined volume could be any one of 25%, 20%, 15%, 10%, or 5% or some other percentage based upon the total capacity of the reservoir. Similar control provisions could be based upon the height of water in the reservoir. Likewise, similar controls can be provided based upon water in the fog production chamber.

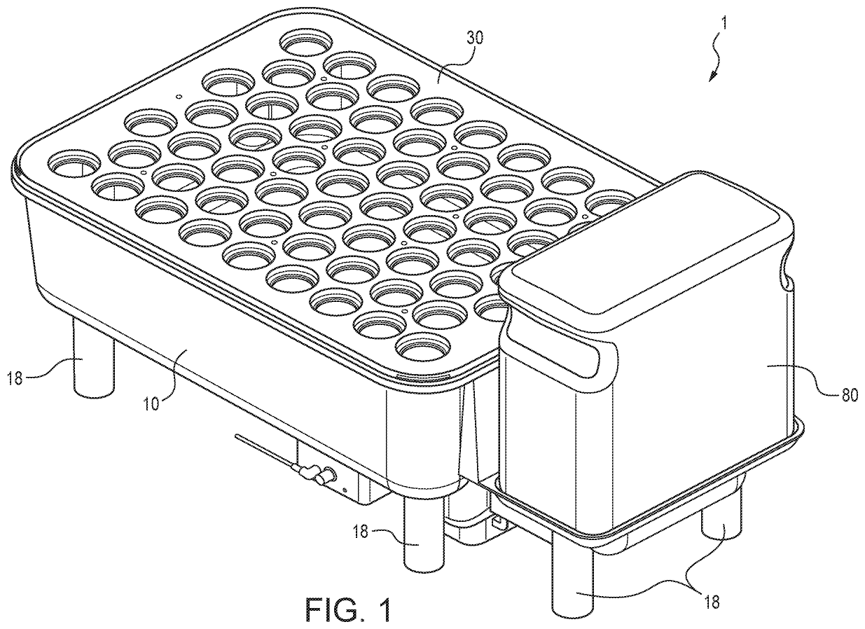

FIG. 1 is a perspective view of an embodiment of a plant growing system 1 in accordance with the present subject matter. The system 1 comprises a receptacle 10, a tray 30 disposed on the receptacle 10, and a water reservoir 80 in communication with the receptacle 10. The system 1 may additionally comprise one or more legs 18.

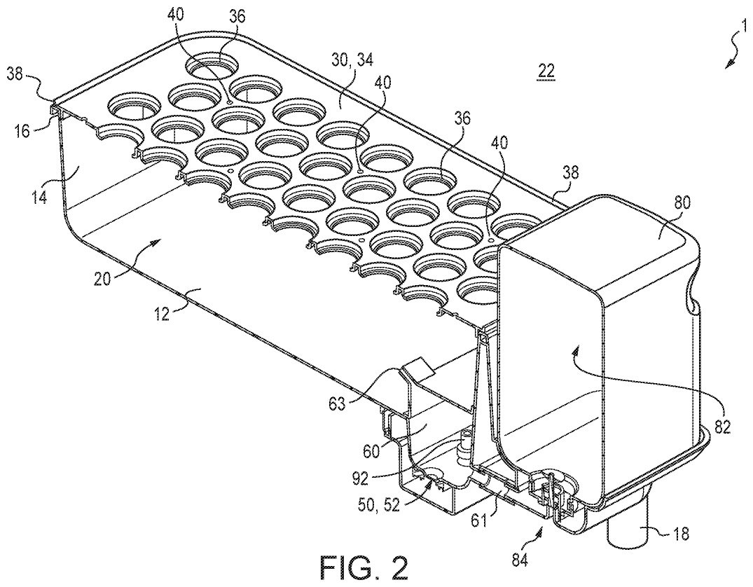

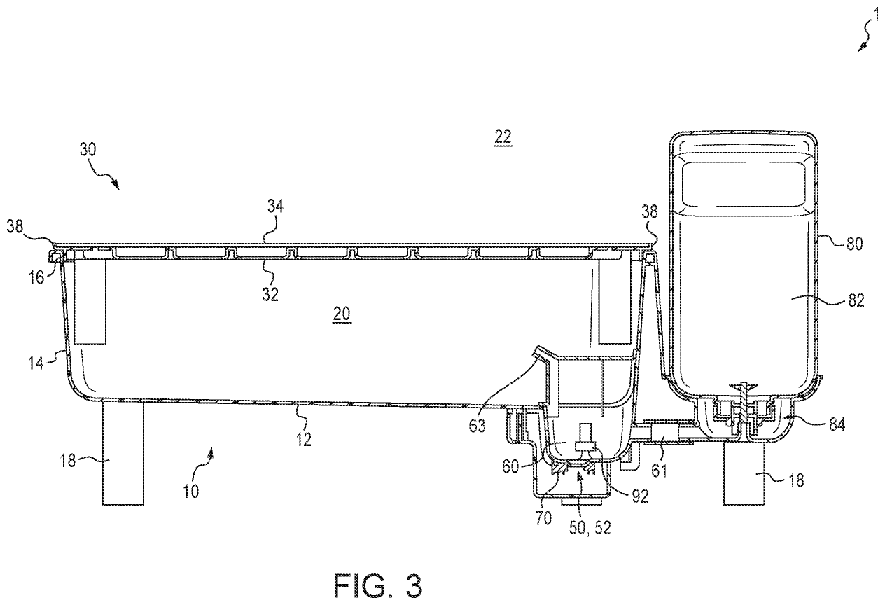

FIGS. 2 and 3 illustrate a cross section taken along a length dimension of the plant growing system 1. These figures further show the receptacle 10 having a bottom wall 12 and one or more sidewalls 14 extending upward from the periphery of the bottom wall 12. The sidewalls 14 extend to a distal edge 16 that defines a receptacle open face. The tray 30 is sized and shaped to be positioned with the receptacle 10. The tray 30 defines an underside 32 and an oppositely directed topside 34. The tray 30 additionally defines a plurality of openings 36 extending between the underside 32 and the topside 34. The receptacle bottom wall 12, receptacle sidewalls 14, and tray underside 32 generally define a receptacle interior region 20. The tray 30 typically includes one or more vents 40 configured to direct water droplets, fog, or mist from the receptacle interior 20 such as from along the underside 32 of the tray 30, to a region along the topside 34 of the tray, i.e., the exterior 22 of the receptacle 10. These figures also illustrate a tray lip 38 generally extending about the periphery of the tray 30. The lip 38 is configured to fittingly engage the distal edge 16 of the sidewalls 14 of the receptacle 10.

Referring further to FIGS. 2 and 3, the plant growing system also comprises a fog production chamber 60. The fog production chamber 60 is in communication with the water reservoir 80 by a water supply port 61. The fog production chamber 60 is in communication with the interior 20 of the receptacle 10 by one or more water droplet, fog or mist discharge ports 63 extending between the chamber 60 and the receptacle interior 20. Disposed in, or immediately below and in communication with, the fog production chamber 60 is one or more generator(s) 50, which as previously noted are typically in the form of piezo-electric element(s) 52. The system 1 also comprises controls 70 for adjusting and/or governing operation of the generator 50. Additional aspects and components of the controls 70 are described herein.

The plant growing system also comprises in particular versions, fail-safe provisions that limit or prevent operation of the system and in particular versions, limits operation of the generator 50 or piezo-electric element 52 if the level of water in the fog production chamber 60 is less than a predetermined minimum water level. An example of such fail-safe provisions are shown in FIGS. 2 and 3 in which a float switch assembly 92 changes state, e.g., opens an electrical circuit, depending upon the amount or height of water level in the fog production chamber.

The plant growing system 1 comprises also the water reservoir 80 which is typically positioned alongside and in close proximity to the receptacle 10. The reservoir 80 defines an interior region 82 for holding water and gravity feed provisions 84 that automatically dispense water contained in the interior 82 of the receptacle 80 to the fog production chamber 60, to maintain a predetermined level of water in the chamber 60.

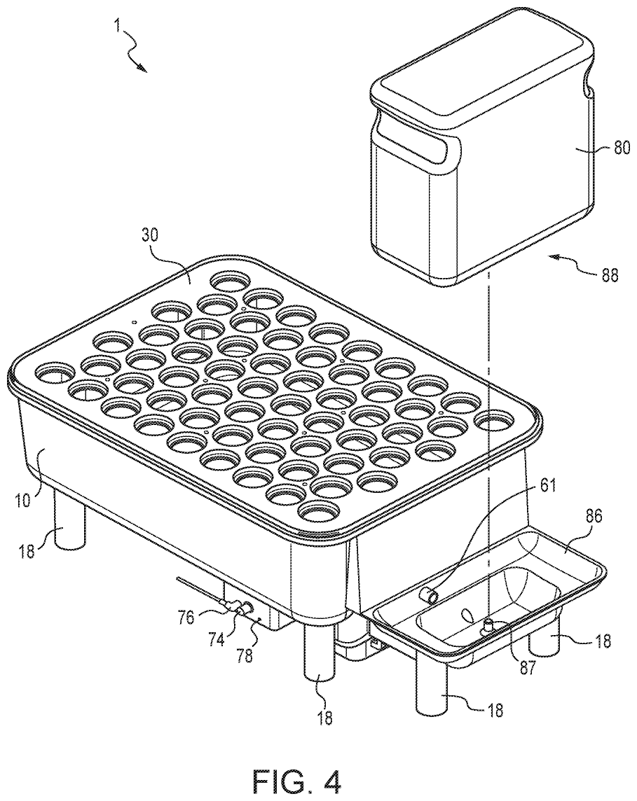

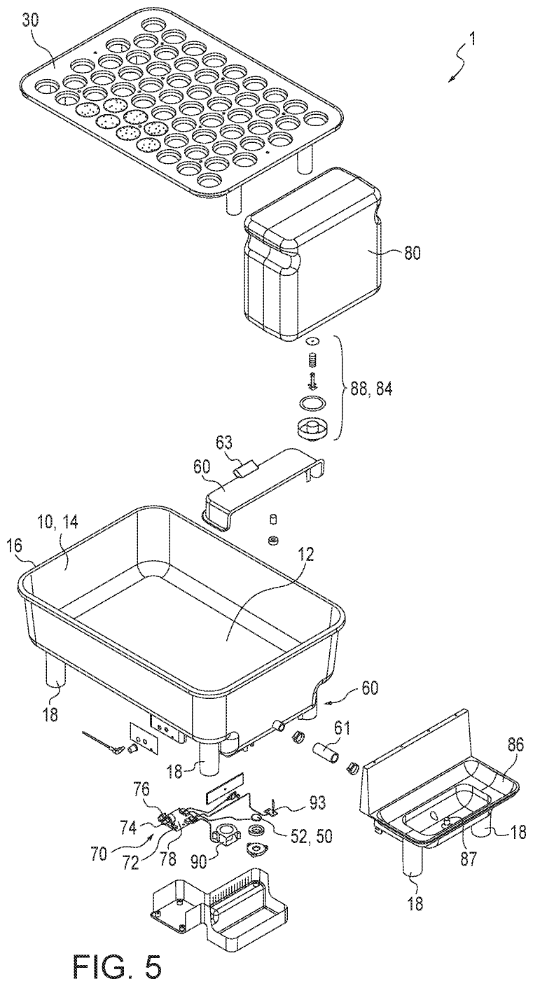

In many versions of the present subject matter, the water reservoir 80 is removable to facilitate filling or adding water thereto. FIGS. 4 and 5 illustrate the plant growing system 1 with the reservoir 80 removed from a reservoir base 86. The reservoir 80 defines an opening (not shown) that is closed by a cap assembly 88 which may also constitute all or a portion of the gravity feed provisions 84. The reservoir 80 is filled or refilled by inverting the reservoir from the position shown in the referenced figures and adding water through the opening. The cap assembly 88 is then fitted over the opening to thereby close the reservoir. The reservoir 80 is then positioned as shown in FIG. 4 and the cap assembly 88 mated with a member 87 exposed and upwardly extending from the reservoir base 86. Upon engagement between the member 87 and the cap assembly 88, water can flow from the interior 82 of the receptacle 80 into the reservoir base 86, through the water supply port 61, and into the fog production chamber 60.

FIG. 5 further illustrates the controls 70 for the generator 50. The controls 70 can be in the form of an electronic assembly generally including a printed circuit board 72. FIG. 5 also illustrates a fan assembly 90 which is powered and controlled via the previously noted printed circuit board 72. The noted piezo-electric element 52 is also powered and controlled by the printed circuit board 72. The printed circuit board 72 can include a selectively adjustable potentiometer 74, an input or jack 76 for receiving electrical power, e.g., 12 Volt DC electrical power, and one or more light(s) 78. In certain embodiments, the printed circuit board 72 can also include a switch 93 that is associated with the switch assembly 92 that serves as a fail-safe provision for operation of the generator 50.

It will be appreciated that the present subject matter includes a wide array of components and component configurations, and is not limited to the particular embodiment depicted in FIGS. 1-5.

The soilless plant growing systems of the present subject matter can be implemented in a low cost, consumer friendly system. The systems can utilize ambient air and light and employ receptacles for retaining water droplets, fog, or mist at atmospheric pressure. The systems provide convenience and are easy to use thereby overcoming many problems of previously known plant growing systems. As noted, in many embodiments of the present subject matter plant growing systems, the systems are free of sensors that sense growing parameters such as temperature, humidity, gas composition, and combinations thereof. Avoiding the use of such sensors and associated controls reduces cost and complexity and typically improves operating reliability of the resulting systems.

### Additional Aspects

### Modular Inter-Connecting Assembly

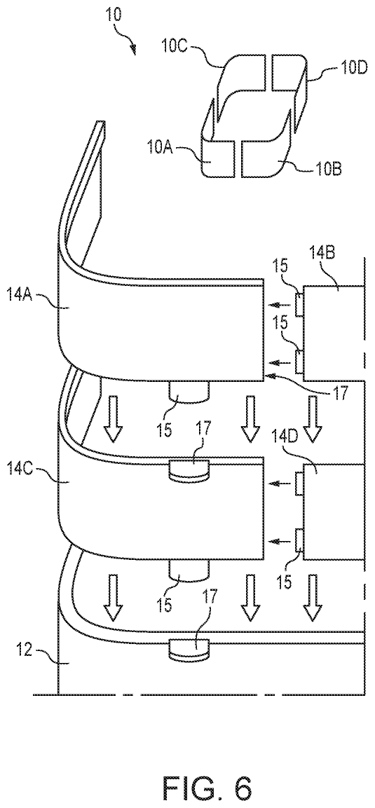

One or more of the components of the growing system and particularly the receptacle can utilize a modular and/or inter-connecting assembly. For example, FIG. 6 illustrates a portion of a receptacle wall or humidity barrier that utilizes a plurality of connecting parts or sections. The receptacle wall or humidity barrier can be formed of an optically transparent material or other suitable material. Use of an inter-connecting assembly for the receptacle wall or humidity barrier in combination with an open top, allows increased transfer of air while retaining water humidity within the receptacle.

Specifically, FIG. 6 illustrates a receptacle 10 formed from engaging together a plurality of receptacle wall portions 10A, 10B, 10C, and 10D. The wall portions can include sidewall portions 14A, 14B, 14C, and 14D. Each wall portion or sidewall portion can include engagement members 15 that are received in regions 17. The engagement members 15 and/or the receiving regions 17 are sized and shaped to engage each other and particularly to frictionally engage each other. The various sidewall portions 14A, 14B, 14C, and 14D and/or the receptacle wall portions 10A, 10B, 10C, and 10D can be configured to engage a bottom wall 12 or similar base using the noted engagement members 15 and/or the receiving regions 17.

### Plant Support System

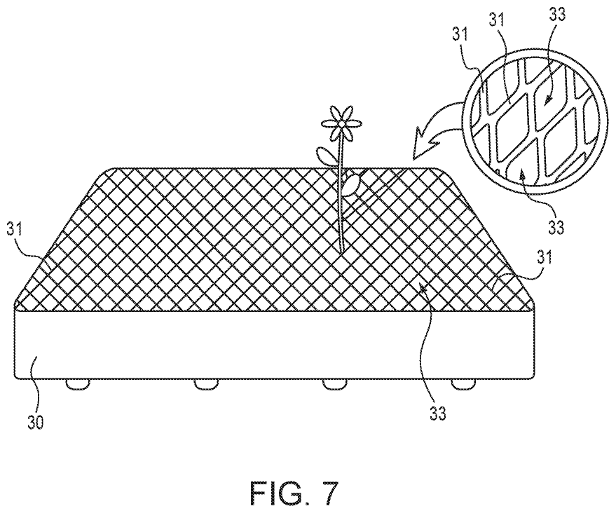

In certain embodiments, the growing system can include a support system that extends over a portion of, or the entirety of, the open top of the receptacle. For example, FIG. 7 illustrates a portion of a receptacle having an open top, and a support system extending over the top. The support system provides support for plants and particularly young growing plants, located under the support system. The support system can be formed from a wide array of materials, which may include for example a hard or rigid plastic. The support system typically includes a plurality of support members and a plurality of openings extending through the support system.

FIG. 7 shows an embodiment of a plant support system, which can for example be in the form of a tray 30 having a plurality of support members 31 extending across a face or region of the tray 30. The support members 31 are spaced apart from each other to define a plurality of openings 33 extending through the thickness of the support members 31 and/or the tray 30. As will be understood, the openings 33 are sufficiently sized and arranged to enable and/or promote plant growth through the tray.

### Indication Panel

In certain embodiments, the growing system can include one or more indication panel(s) that provide information to a user. If the plant growing system includes one or more sensor(s) or other measurement devices for example, output(s) and/or information from the sensor(s) and/or device(s) can be displayed at the indication panel(s). Non-limiting examples of such sensor(s) or measurement device(s) include those for monitoring or measuring temperature, light or light characteristics such as wavelength and/or intensity, humidity, water level, time sensors or timers that measure time until refill or other event for example, fog parameter(s) such as fog generation rates or fog concentration, and combinations of these.

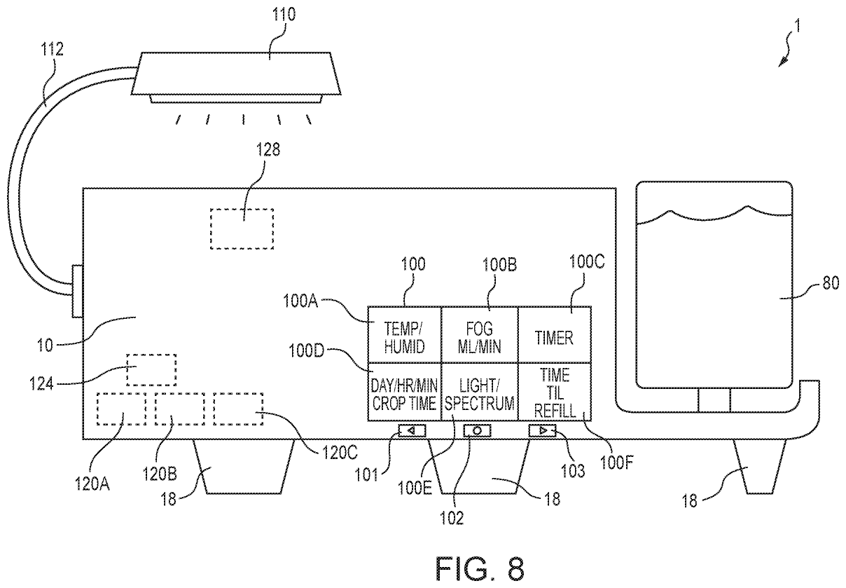

FIG. 8 illustrates a growing system 1 having an indication panel 100. The indication panel 100 is typically mounted on an exterior region of the receptacle 10 and/or the water reservoir, however other locations are contemplated. The indication panel 100 can include multiple indicators, screens, lights, display elements, or the like. FIG. 8 schematically depicts indicators 100A, 1006, 100C, 100D, 100E, and 100F. The indication panel 100 can also include one or more user input switches, controls, actuators, or the like which are schematically shown as controls 101, 102, and 103.

### Plant Lighting

In particular embodiments, the growing system can include one or more light(s) that are configured and/or positioned to provide light suitable for plant growth, to plants located in the receptacle. FIG. 8 depicts a representative light 110 positioned to direct light toward plants within the receptacle. A wide array of lights can be used. In a preferred version, the lighting element is an LED element with a controllable intensity and spectrum.

Specifically and with further reference to FIG. 8, the light 110 can be supported on the growing system or component thereof such as the receptacle 10 by a light support member 112. Preferably, the light support member 112 is flexible to thereby provide an adjustable or selectively positional light which can be oriented as desired to direct light toward or away from plants.

### Sensors

As noted, in certain embodiments, the growing system can include and utilize sensors for monitoring and/or measuring temperature, light or light characteristics such as wavelength and/or intensity, humidity, water level, time sensors or timers that measure time until refill or other event for example, fog parameters, and/or combinations thereof. FIG. 8 also illustrates a growing system comprising one or more of those sensors. Specifically, the growing system 1 can include one or more sensors 120A, 120B, and 120C for example. These sensors are schematically depicted, and it will be understood that the sensors 120 can be located anywhere in association with the growing system 1.

### Timers

In certain embodiments, the growing system can include one or more timers which preferably are adjustable and/or resettable and which enable a user to selectively adjust time periods between watering and/or fog generation or other event(s). This enables growing of plants with relatively low water requirements, and/or the use of different growing mediums. FIG. 8 schematically illustrates a timer, which can for example be incorporated near or adjacent an indication panel. Specifically, the growing system 1 can include one or more timers 124. As will be understood, the timer(s) are typically in data and/or electrical communication with the controls and/or power components of the system 1.

### Heaters

In particular embodiments, the growing system and particularly the receptacle, can include one or more heaters to heat and/or maintain a desired temperature typically within the receptacle and/or the growing system. For example, in certain growing applications, it may be desirable to maintain the temperature within the interior of the receptacle to 82° F. or approximately so. The heater(s) can be located at any suitable location in the system and particularly the receptacle. FIG. 8 illustrates a representative heater. Specifically, one or more heater(s) 128 can be located in or adjacent the receptacle 10. It is also contemplated that the heater(s) could also be used to heat water in the reservoir 80. Although a wide array of heaters can be used, electrical resistance heating elements have been found to be suitable.

### Wireless Communication and Inter-Connectivity

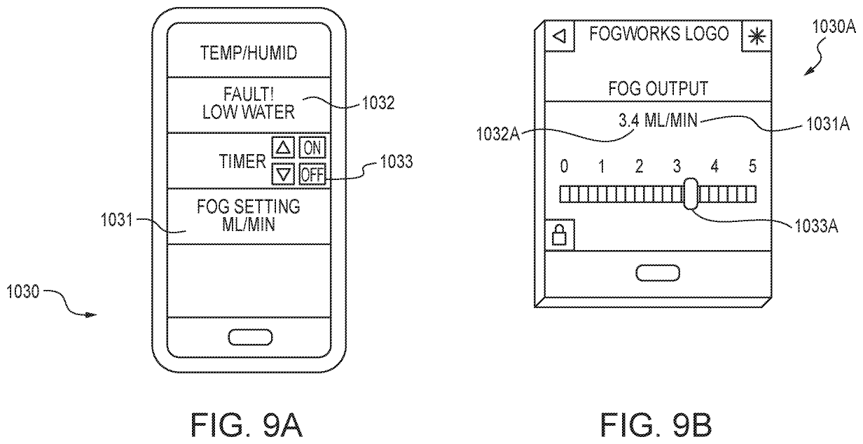

In certain embodiments, the growing system can include provisions for wireless communication and/or wireless inter-connectivity. For example, such provisions enable wireless communication between the growing system and a mobile device and/or a desktop computer. Non-limiting examples of a mobile device include a smartphone, a tablet computer, and/or a laptop computer. As known in the art, the smartphone may be configured with an algorithm typically referred to as an “App” which provides a convenient interface for a user. FIG. 9A illustrates a smartphone with a screen displaying growing system data presented via an App running on the smartphone. A wide array of wireless communication protocols can be used such as for example Bluetooth and/or Wi-Fi. These provisions can be configured to enable the growing system to send information or messages to a mobile device upon occurrence of a fault or alarm condition. These provisions can also be configured to enable a user to control operational aspects of the growing system such as but not limited to fog volume, temperature, . . . etc. These provisions may also enable a user to monitor aspects such as humidity, temperature, or other parameters within the system and particularly the receptacle. These provisions can also provide information as to amount of time remaining prior to a low water level or state. Such determination could be made for example by monitoring fog production rate and using current water level to extrapolate or otherwise compute a low water level or state. FIG. 9B illustrates an indicator of output rate with a graphical output. Additional details and aspects of wireless communication and inter-connectivity are provided herein and particularly in a description of networks of multiple plant growing systems.

Specifically, FIG. 9A illustrates a smartphone 1030 or other mobile device having a display 1031. The smartphone 1030, upon executing an App associated with controlling, operating, and/or otherwise interfacing with a growing system, provides information 1032 to a user. The information 1032 may include text, numbers, symbols, lights and/or other indicia which can provide information such as but not limited to temperature, humidity, fault conditions, water level, fog parameters, and the like. The smartphone 1030 can also provide user inputs or input controls 1033 for enabling a user to make changes, adjustments, and/or variations in the operation of the plant growing system 1. The user inputs or controls 1033 can also be in the form of on/off controls, resets, and the like. FIG. 9B illustrates another mobile device 1030A which can for example be in the form of a laptop computer or tablet as known in the art. The mobile device 1030A includes communication provisions as described herein. The mobile device depicted in FIG. 9B is programmed to provide a fog output controller. The mobile device 1030A includes a display 1031A for providing information 1032A, and one or more inputs 1033A that enable a user to adjust operational aspects of the growing system.

### Nested Support

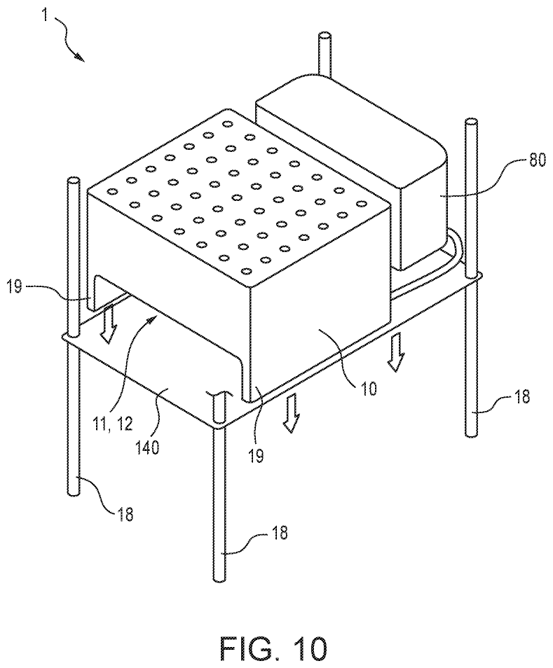

In certain embodiments, the growing system and particularly the receptacle can utilize a nested support configuration in which a region of the receptacle or other portion(s) of the growing system defines a recessed receiving region sized and shaped to receive, contact and/or engage a shelf or other planar support surface. FIG. 10 illustrates an example of a receptacle having a recessed bottom region which is sized and shaped to receive, contact, and/or engage a shelf. The shelf may be part of the growing system, or alternatively may be an external or third-party supplied shelf.

Specifically, FIG. 10 illustrates a growing system 1 having a receptacle 10 and a water reservoir 80 as described herein. The reservoir 10 includes a recessed region 11, preferably along a bottom wall 12, that is sized and shaped to receive a shelf or support 140 upon placement of the reservoir 10 or growing system 1 thereon. The shelf or support 140 can be a component of the growing system 1, and if so, may be configured to utilize or be combined with one or more legs 18 of the growing system 1. In particular embodiments, the reservoir 10 includes one or more extension members 19 that serve to align and/or retain the receptacle 10 relative to the shelf or support 140. The extension members 19 define the recessed region 11 extending therebetween.

### Interchangeable Lids or Trays

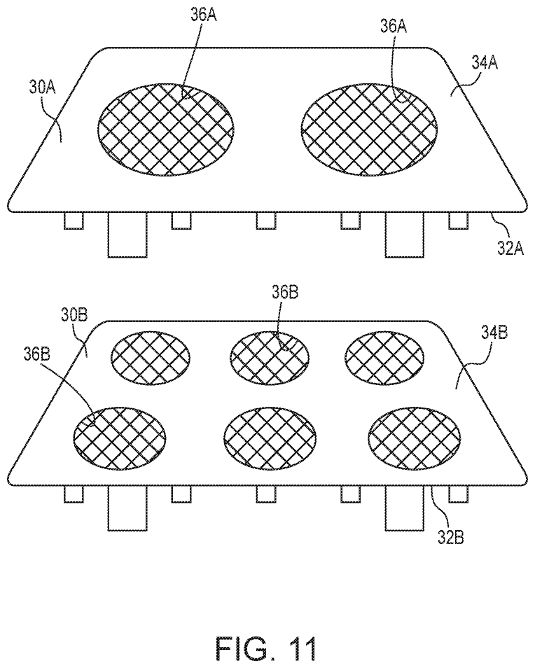

In still additional embodiments, the growing system can include one or more interchangeable lids and/or trays having particular features. Typically, the lids and/or trays are configured, i.e., sized and shaped, to fittingly engage or fit within a receptacle of the growing system. The lids and trays can be individually tailored for certain applications and/or for use with particular plants. For example, FIG. 11 illustrates two trays having openings or apertures of different sizes. For example, a tray with relatively large openings may be desirable for growing lettuce plants. The tray(s) can include one or more biodegradable collar(s) or plug(s) for cuttings to be transplanted with a respective plant. Interchangeable lids or trays can also be provided in growing systems that are relatively small or which feature a small “footprint.” This enables small tabletop growing systems with different interchangeable lids or similar sleeves or covers, that a user can change to vary the appearance, i.e., color or pattern, of the lid.

Specifically, FIG. 11 illustrates a tray 30A and a tray 30B. Each tray defines a topside 34A, 34B; and a corresponding underside 32A, 32B. The tray 30A defines two relatively large openings 36A, and the tray 30B defines six relatively small openings 36B. One or more of the openings 36A, 36B may optionally include a netting or other member(s) extending across a portion or entirety of an opening.

### Water Filtration, Nutrient Delivery, and pH Adjustment

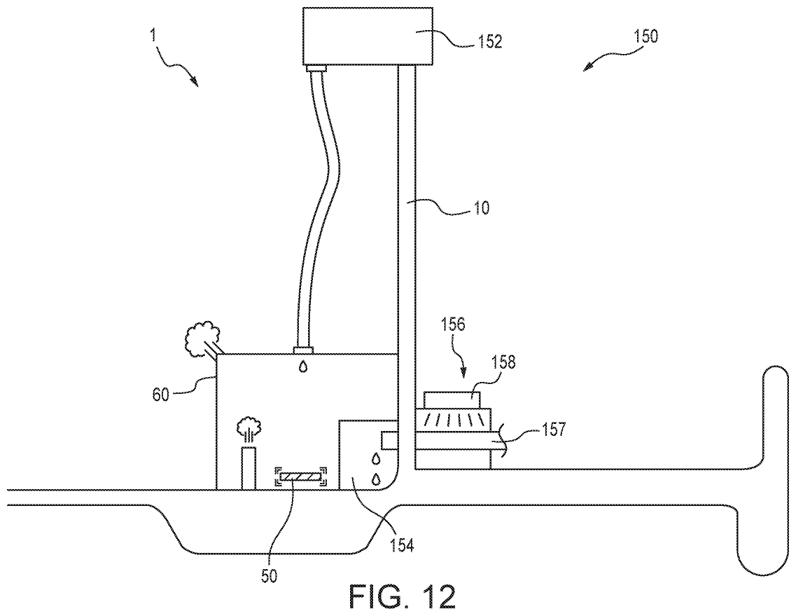

In certain embodiments, the growing system includes a water filtration system. Typically, the system is located on-board or integral with the growing system. The water filtration system includes one or more sediment filter(s), one or more activated carbon element(s), one or more UV light emitter(s), and/or combinations of these components. FIG. 12 schematically illustrates an embodiment of a water filtration system incorporated in a growing system in accordance with the present subject matter. The growing system can also in a particular embodiment, include a system for delivering nutrient(s) to the plant growing environment such as within the receptacle. A variety of nutrient delivery or “dosing” systems can be used, but a nutrient cartridge is preferred as it provides convenient administration of nutrient(s) to the water reservoir and/or the fog production chamber. In addition, in many applications the system for delivery nutrient(s) is passive or active. FIG. 12 also illustrates an example of a nutrient cartridge for adding or otherwise administering nutrient(s) to the growing system. Either or both of the water filtration and/or the nutrient delivery system can be equipped with self cleaning provisions. Such provisions may utilize piezo action. The water filtration and/or nutrient delivery systems can optionally include provisions for pH adjustment.

Specifically, FIG. 12 illustrates a water filtration system 150 incorporated in a growing system 1. The water filtration system 150 includes a nutrient delivery component 152, which as noted can be in the form of a nutrient cartridge or cartridge system. The nutrient delivery component receives water or fog and directs such through nutrient. Passage of water or fog through or across nutrient, results in transfer of nutrient or nutrient agents into the water/fog. Nutrient-rich water, droplets, or mist is then directed into the receptacle 10 and/or the fog production chamber 60. The system 150 can also include one or more filters 154 or adsorbent media through which water is passed. Pollutants, contaminants, or other unwanted agent(s) in the water are removed by capture by the filters or adsorbent media. The filtered water is then directed to the receptacle 10 and/or the fog production chamber 60. A non-limiting example of a filter is a charcoal filter. The system 150 may also include a UV light emitter 156 located near or proximate a water supply 157. The UV light emitter includes one or more light emitting elements 158 that emit light having a light wavelength within the ultraviolet (UV) range, and at an intensity suitable for killing or otherwise disinfecting against pathogens or other contaminants as known in the art.

### Seed Starting Mat and Interchangeable Tray or Lid

In certain embodiments, the growing system can include one or more seed starting mat(s) which can optionally be used with one or more interchangeable tray(s) or lid(s). The seed starting mat is typically formed from a hydroponic growing medium which is porous and allows passage and/or transfer of air, water, water vapor, and/or water mist droplets through the mat. The seed starting mat is also sufficiently strong to support plants growing therein. The seed starting mat is also compatible with plant roots growing within the porous mat structure. The seed starting mat may be formed from a wide array of suitable materials. Non-limiting examples of suitable materials include, but are not limited to, (i) coconut coir fiber, (ii) rockwool flock, and combinations of (i) and (ii).

Coconut coir fiber is a natural fiber extracted from the outer husk of coconut and used in products such as floor mats, doormats, brushes, and mattresses. Coir is the fibrous material found between the hard, internal shell and the outer coat of a coconut. Coir fibers are found between the hard, internal shell and the outer coat of a coconut. The individual fiber cells are narrow and hollow, with thick walls made of cellulose. They are pale when immature, but later become hardened and yellowed as a layer of lignin is deposited on their walls. Each cell is about 1 mm (0.04 in) long and 10 to 20 μm (0.0004 to 0.0008 in) in diameter. Fibers are typically 10 to 30 centimetres (4 to 12 in) long. The two varieties of coir are brown and white. Brown coir harvested from fully ripened coconuts is thick, strong and has high abrasion resistance. It is typically used in mats, brushes and sacking. Mature brown coir fibers contain more lignin and less cellulose than fibers such as flax and cotton, so are stronger but less flexible. White coir fibers harvested from coconuts before they are ripe are white or light brown in color and are smoother and finer, but also weaker. They are generally spun to make yarn used in mats or rope.

Rockwool, a fibrous “wool” or flock material, was first discovered occurring naturally on Mauna Loa volcano in Hawaii. It was first manufactured in about 1935 for use as an insulating material for buildings. The manufacturing process involves melting forms of basaltic rock at temperatures of 1,500° C., incorporating additives and then feeding a stream of the molten mixture onto a drum that is rotating at great speed and which spins the molten mass into fibers.

The seed starting mat of the present subject matter may include nutrient(s) incorporated into the mat which upon exposure to water, water vapor, and/or water droplets, are released for uptake by plants or seeds. The nutrient(s) and/or mat may include one or more agents for delaying release such as over the course of several days or weeks for example. The seed starting mat may also include one or more seed(s) incorporated within the porous structure of the mat. A wide array of seed types can be used such as for example organic and/or traditional seeds. Alternatively, the mat can be free of seeds and ready for receiving seeds from a user. The seed starting mat can also exhibit different or varying degrees of porosity. For fibrous, tightly woven mats may be preferred for certain plants, and loosely woven mats may be preferred for other types of plants. The seed starting mats may also vary by mass or density. Certain seeds may germinate more readily in relatively dense mats, and other seed types may germinate better in less dense mats.

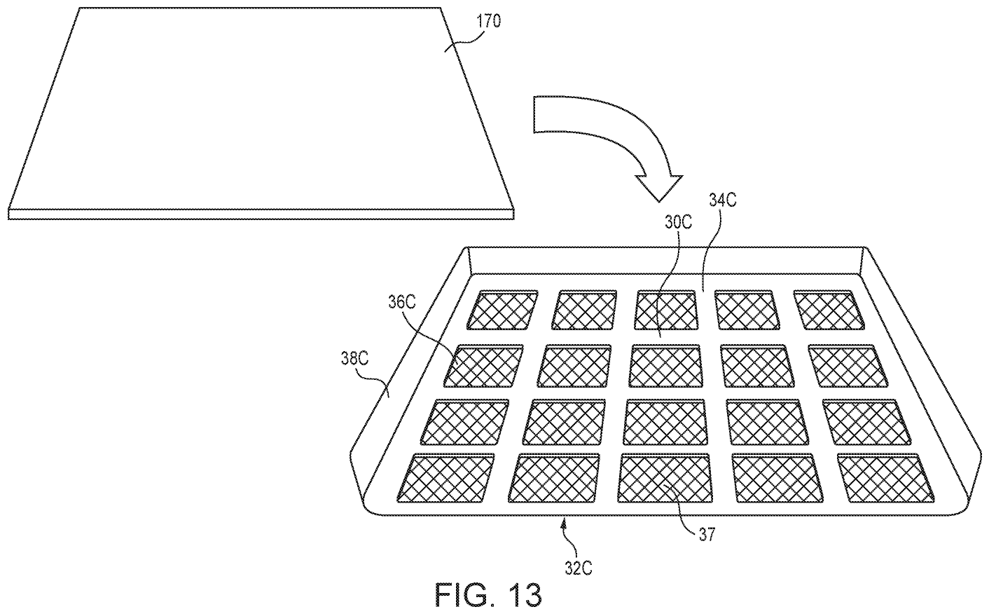

The seed starting mats are optionally used in association with a tray or lid as illustrated in FIG. 13. Generally, the tray is used to support or otherwise retain the mat and is located or placed in the receptacle of the plant growing system. The tray may include one or more openings or apertures. A lid may also be used in association with the tray to cover, either partially or entirely, the face(s) or the tray and mat supported therein. Either or both of the tray and/or lid may include a lip or groove extending around their perimeter. Typically, the tray includes a lip or groove extending around its perimeter for engaging a corresponding lip or groove on a lid or other component of the growing system. Alternatively, the lip/groove promotes or enables multiple tray(s) and/or lid(s) to be used in a stacking arrangement. The lids can be transparent, opaque, or translucent. In many applications, it is preferred that the lid be opaque to prevent light from passing through the lid. This enables the lid to be used as a “black-out” lid when positioned on a tray.

The trays and/or lids may be used with optional aesthetic sleeve(s) and/or cover(s) that are configured, i.e., sized and shaped, to fittingly enclose or cover the tray or lid. Such sleeve(s) or cover(s) can be provided in a wide array of colors or patterns and enable a user to tailor the appearance of the growing system or components thereof as desired.

The seed starting mats, trays, and/or lids may be provided in a wide range of sizes. A shorter and more compact design may be used in growing systems in which root zone space is not needed or is minimal. The components of the mats, trays, and/or lids may be relatively small for growing systems that are configured for home counter use or placement. Larger components may be used with growing systems that are sized to fit entire shelf surface areas of traditional shelving units. The trays may be configured, i.e., sized and shaped, to be used with nursery flat size mats. For example, trays may be sized such that four (4) trays fit side-by-side on a traditional or conventional nursery shelf.

Specifically, FIG. 13 illustrates an embodiment of a tray 30C defining a topside 34C, an underside 32C, and a plurality of openings 36C extending about the periphery of the tray 30C. Optionally, one or more, or all, openings 36C can be fitted with screens 37 or netted material(s). As will be understood, a seed starting mat, schematically depicted as mat 170, can be placed on or within the tray 30C. In accordance with an aspect of the present subject matter, this configuration of an apertured tray supporting a seed starting mat used in a soilless growing environment as described herein, is believed to be unique and novel.

### Modular Commercial Propagator

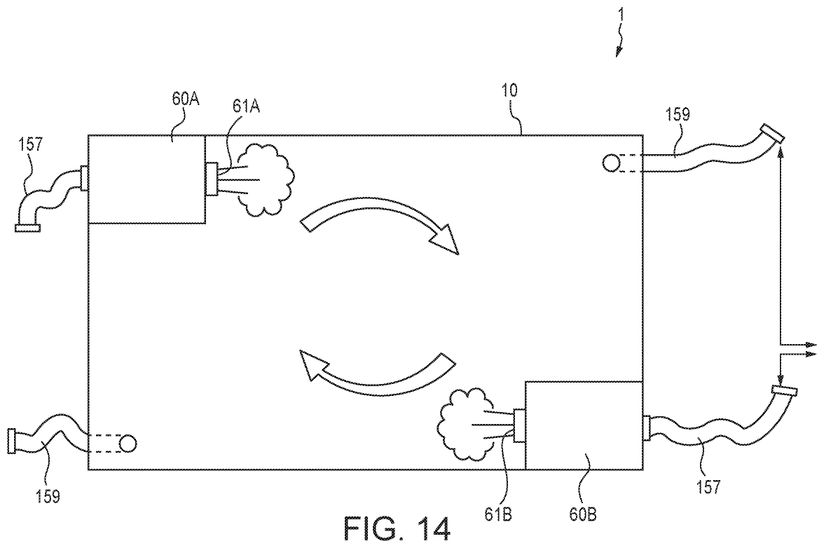

In certain embodiments, the growing system is provided in the form of a modular commercial style plant propagator. Typically, such systems accommodate at least 200 plants and may optionally include two (2) or more fog production chamber(s). In certain versions, the chamber(s) are configured to produce a circular flow of fog, and may additionally include redundancies such as a back-up water supply system and/or fog or water droplet generator system. FIG. 14 is an illustration of an example of one version of a commercial plant propagator. It will be understood that the present subject matter includes other versions such as plant propagators using a single fog or water vapor droplet generator system.

Referring to FIG. 14, a plant growing system 1 in the form of a commercial propagator is shown. The system 1 includes a first fog production chamber 60A and a second fog production chamber 60B. Although a variety of locations for the chambers 60A, 60B could be used, in this embodiment the chambers 60A, 60B are located at opposite corners of the receptacle 10. Each chamber directs fog or corresponding emission(s) outward through corresponding outlets 61A, 61B. These aspects result in a circular or oval pattern of air/fog flow within the receptacle 10. The system 1 and particularly the receptacle 10 can include provisions for receiving water from water supply lines 157, and directing water through drain lines 159. Quick connect fittings can be used on water supply lines 157 and/or drain lines 159.

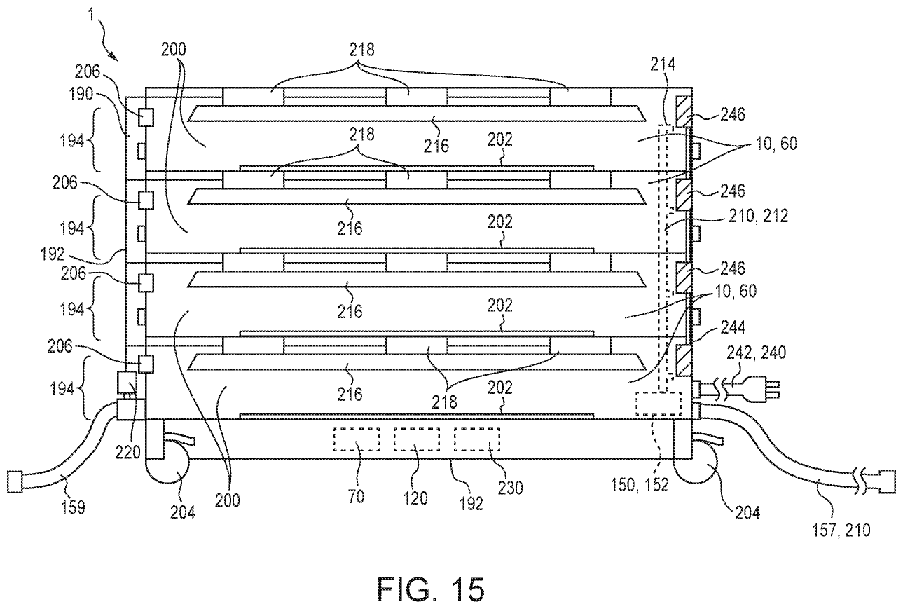

In particular embodiments, collections of modular plant propagators may be used with a rack unit. This configuration enables large numbers of plants to be grown, monitored, and/or managed. FIG. 15 illustrates a plant propagator system comprising a rack unit with a plurality of modular plant propagators. The rack unit includes a collection of module receiving regions. Such receiving regions of the rack unit can include assemblies for slidingly engaging with modules, supporting modules, and/or facilitating connections for electrical, ventilation, water supply, drainage, and/or combinations of these. The rack unit may include a variety of features and/or components as follows. One or more roller(s) or wheel(s) can be provided along a lower region or underside of the rack unit to facilitate moving the rack unit. The roller(s) or wheel(s) may be swivellable and/or include locking provisions to prevent movement. The rack unit and particularly its module receiving regions can be in the form of, or include, shelves. Such shelves can include roller or slide assemblies that enable a shelf to be extended outward from the rack unit and retracted into the rack unit. Such shelves may include handles or other gripping members. Similarly, handles or gripping members could be provided on the exterior of the modular plant propagator(s). The rack unit may also include a water distribution system. Typically such a system includes a water inlet at which a water source is connected, and one or more water distribution lines that direct water from the inlet to module receiving regions. In many versions, each module propagator includes provisions for receiving water. The water distribution system may include a water manager unit that controls flow of water from the water inlet to one or more modules. The water lines connect to modules via quick connections or other convenient assemblies as known in the art. The rack unit can also include one or more lighting units which are preferably LED lights. Although the arrangement and configuration of lights may vary, a typical arrangement is to provide controllable LED lighting under or adjacent each shelf, or in each module receiving region. Preferably, each light or set of lights is located above a module. This enables a user to selectively control lighting for each module within the rack unit. The rack unit can also include controllable ventilation and particularly such ventilation between shelves or module receiving regions. One or more barrier(s) can be provided and located between shelves or module receiving regions to direct or collect excess humidity or water cascading from an upper location. The rack unit can additionally include one or more condenser(s) that serve to condense water vapor or humidity within the rack unit and/or module(s), to liquid water. Such condenser(s) can be in the form of condensing coils or other heat transfer components. Representative examples include a condensing coil located in a fresh water bath, or stackable ceramic discs as used in conventional reflux stills. The condenser(s) preferably direct the condensed liquid, i.e., water, to a waste water or drainage line in the rack unit. The rack unit may also include a drainage system that includes drain lines that extend to each shelf or module receiving region and a common drainage container or drain outlet. Quick connections can be used. The main drain outlet of the rack unit can be configured to engage with a wide variety of hose connections. The rack unit may also include a cover or enclosure that partially or entirely encloses the rack unit with its associated modules. This may enable greater control over the growing environment within each module. The cover or enclosure may be in the form of a flexible wall bag which is generally transparent to promote entry of light. A wide array of covers or enclosures can be used. It is also contemplated to utilize rigid wall covers or enclosures.

The rack unit may also include electronic controls and/or sensors to monitor, control, or otherwise facilitate plant growth. Electronic controls are described herein. Sensor(s) or monitor(s) may be used to show conditions such as humidity in root zone(s) and/or shoot area(s); temperature(s) in such areas, light intensity, fog or water vapor sensors that may optionally indicate sensors for assembly production rates, timer values for intermittent fog production, timer values for assessing crop growth, ventilation parameters or ventilation rates including circulation characteristics, and combinations of these sensors and/or factors.

The rack unit typically includes an electrical power management system (EPMS). Such systems include connection provisions for receiving electrical power from a power source, power distribution to each shelf or module receiving region within the rack unit, and power monitoring and/or safeguard components such as surge controllers, voltage and current sensors, and the like. It is also contemplated that the rack unit could include one or more battery back-ups. The power distribution system can also provide outlets for supplying power to accessories and at different voltage levels. In certain applications, the rack unit can also include one or more camera(s) or video unit(s) for visually monitoring region(s) within or around the rack unit.

In still additional applications, the rack unit can include a nutrient/pH dosing system in which one or more reservoirs within the rack unit supply nutrient(s) and/or pH adjusting agents to water supply lines at particular shelves or module receiving regions within the rack unit. The nutrient/pH dosing system can include passive or active dosing along with one or more sensors for assessing pH levels and/or electroconductivity levels or other parameters.

Specifically, FIG. 15 illustrates a plant propagator system 1 comprising a rack unit 190 and a plurality of modular plant propagators 200 removably disposed within the rack unit 190. Each modular plant propagator 200 includes a receptacle 10 and at least one fog production chamber 60 with corresponding components as described herein. The rack unit 190 includes a support frame 192 that typically includes vertical and horizontal support members affixed together to define an interior region. The support frame 192 defines a plurality of receiving regions 194, each of which is configured, i.e., sized and shaped, to receive a modular plant propagator 200. Each of the modular plant propagators 200 is configured, i.e., sized and shaped, to fit within a corresponding receiving region 194 of the rack unit 190. In particular versions, the plant propagator system 1 also comprises a plurality of assemblies 202 for slidingly engaging a modular plant propagator 200 with the rack unit 190 and particularly, each modular plant propagator 200 within a corresponding receiving region 194 of the rack unit 190. The system 1 can also utilize one or more rollers or wheels 204 typically located along a lower region of the rack unit 190. One or more, and typically each, of the modular plant propagators 200 include handle(s) or gripping members 206.

The plant propagator system 1 may also include a water distribution system 210. The water distribution system 210 includes a water supply line 157 which generally extends from the rack unit 190 and may include one or more fittings or connections to facilitate connection to a water source. The water distribution system 210 also includes a water distribution manifold 212 that extends from the water supply line 157 to one or more, and preferably to each, of the plant propagator modules 200. As will be understood, preferably quick connect fittings can be used, such as fittings 214 to provide connection at each module 200. The water distribution manifold 212 can be located along one or more external regions of the rack unit 190 and/or located along one or more internal regions of the rack unit 190. The plant propagator system 1 or more specifically, the rack unit 190 can include one or more lighting units 216. The lighting units 216 preferably use LED lights. Preferably, each lighting unit 216 or collection of lighting units 216 is located above a corresponding receiving region 194 such that upon placement of a plant propagator module 200 in a corresponding receiving region 194, the lighting unit(s) direct light toward plant(s) or seed(s) in the module 200. The plant propagator system 1 or more specifically, the rack unit 190 can include one or more air movement devices such as fans 218. As shown in FIG. 15, preferably one or more fan(s) 218 is located above or proximate a corresponding receiving region 194 so that the fan(s) 218 can direct air flow between the collections of plant propagator modules 200 within the rack unit 190. The plant propagator system 1 or more specifically, the rack unit 190, can also include one or more condenser(s) 220 for condensing water vapor or humidity within the rack unit 190 and/or modules 200, to liquid water. Preferably, the condenser 220 is in flow communication with a drain line 159 for directing water or other liquid from the system 1 and/or rack unit 190 to a drain or other location. FIG. 15 further schematically illustrates various controls for fog production 70, sensor(s) 120, and additional controls 230 for operating various aspects of the plant propagator system 1.

Specifically, FIG. 15 also illustrates an electrical power management system (EPMS) 240. The EPMS includes a power supply cord 242 for connecting to a source of electrical power. Typically, such sources are in the form of 120 VAC or 240 VAC power outlets. However, the present subject matter is not limited to such. The EPMS also includes an electrical power distribution member 244 that transfers electrical power from the supply cord 242 to one or more electrical outlet(s) or connector(s) 246. As will be understood, in a particular versions of the plant propagator system 1, the connectors 246 provide electrical communication to plant propagator module(s) upon receipt in corresponding receiving region(s) of the rack unit 190.

The plant propagator system 1 and particularly the rack unit 190 can also include a water filtration system such as the previously described water filtration system 150. The system 150 can include a nutrient delivery component 152 which as previously noted can be in the form of a nutrient cartridge system.

### Variant Fog Production Chamber(s) and Fog Handling Systems

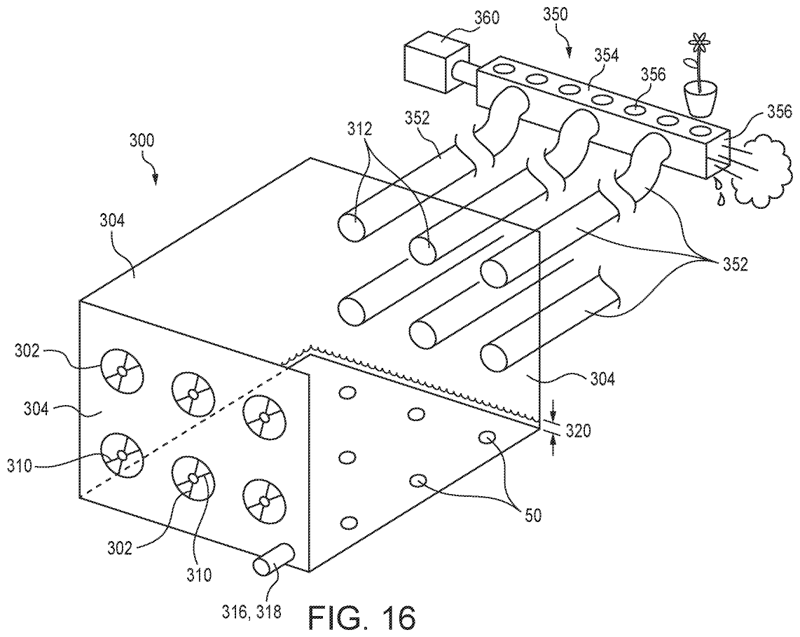

The present subject matter also provides various fog production chambers and fog handling systems. FIG. 16 illustrates another embodiment of a fog production chamber, with a fog handling or transfer system. The fog production chamber includes a solenoid for controlling water flow within one or more supply lines. A wide array of connection fittings can be used, such as for example a conventional hose fitting. The fog production chamber also includes a drain or drain outlet. The outlet may also include a hose fitting. The fog production chamber may also include a reservoir for holding water. Such reservoir may be a primary or a back-up reservoir for redundancy. The fog production chamber and/or handling system may also include quick connections between fog delivery lines that extend to individual growing chambers or if used in the rack unit, to modules of the rack unit. The fog production chamber and/or fog handling system can also include one or more smart sensor(s) to detect new hose or fog line addition(s) and increase fog supply or fog supply rate(s) automatically. The fog production chamber can utilize multiple piezo-electric fog generators or emitters as well as air moving elements such as fans. Systems of these in redundant arrangements are also contemplated.

FIG. 16 also illustrates formation or promotion of formation of NFT gullies, and tubes or gutters with covers and holes for net pots. A correctly designed NFT gully promotes a Nutrient Film Technique by allowing a thin film of oxygenated nutrient solution to flow along a base of a flat bottom gully surface from which the root system of a plant can feed. Failure to use a well designed gully can lead to continuous problems such as ponding, blockages, and deep nutrient flows which starve the root system of oxygen leading to root death, root disease, and crop losses. Fog is introduced through holes in a receptacle with relatively large hose connections. Such holes/connections can be located on sidewalls, a bottom face, and/or end(s) of the receptacle. In certain versions, the receptacle is slightly tilted to aid in condensed water flowing toward waste outlet(s) and/or to filtration components for recirculation. It is also contemplated that water may be introduced in a laminar, non-turbulent flow at a base or dedicated region of the receptacle or gutter for redundancies. In addition, such flow may include nutrients such as large molecule nutrients and/or organic living solutions. It is also contemplated that quick acting nutrients can be added for addressing potential growing deficiencies.

Specifically, FIG. 16 illustrates an embodiment of a fog production chamber 300 with an embodiment of a fog handling system 350 in accordance with the present subject matter. The fog production chamber 300 can include a plurality of fans 310 mounted in air inlet openings 302 of chamber walls 304. The fans 310 direct air external to the chamber 300, into or within an interior of the chamber 300. The fog production chamber 300 can also include a plurality of fog generators 50, which as previously described, can be in the form of piezo-electric units. Such units may include piezo-ceramic transducers. The fog production chamber 300 also includes a plurality of fog outlet apertures 312 defined in the chamber walls 304. The fog production chamber 300 can also include a solenoid valve 316 and drain assembly 318 that can be connected to a hose, conduit or other member for controlling flow of liquid to or from the chamber 300. As will be understood, the solenoid valve 316 is typically controlled by an electrical control signal that may originate from a controller or the user. The solenoid valve 316 and associated control thereof can be used to achieve and/or maintain a desired level of liquid, i.e., water, in the chamber 300. FIG. 16 schematically illustrates a level or layer of water as 320. As noted, the fog production chamber 300 can be oriented or tilted to promote flow of condensed liquid through or toward the solenoid valve 316 and the drain assembly 318.

The fog handling system 350 depicted in FIG. 16 generally includes a plurality of fog conduits 352 that extend between the fog outlet apertures 312 and a fog collection manifold 354. The fog manifold 354 may include one or more plant openings 356 for receiving plants such as in net pots and exposing such to fog within the manifold 354. The fog handling system 350 can also include a collection container 360 for liquid such as water condensed from fog within the fog collection manifold 354. The fog manifold 354 can also define an outlet 356 through which fog is directed potentially to other components or simply as waste fog. The fog conduits 352 and/or fog manifold 354 can be formed from a wide array of materials such as PVC.

### Variant Plant Growing Systems

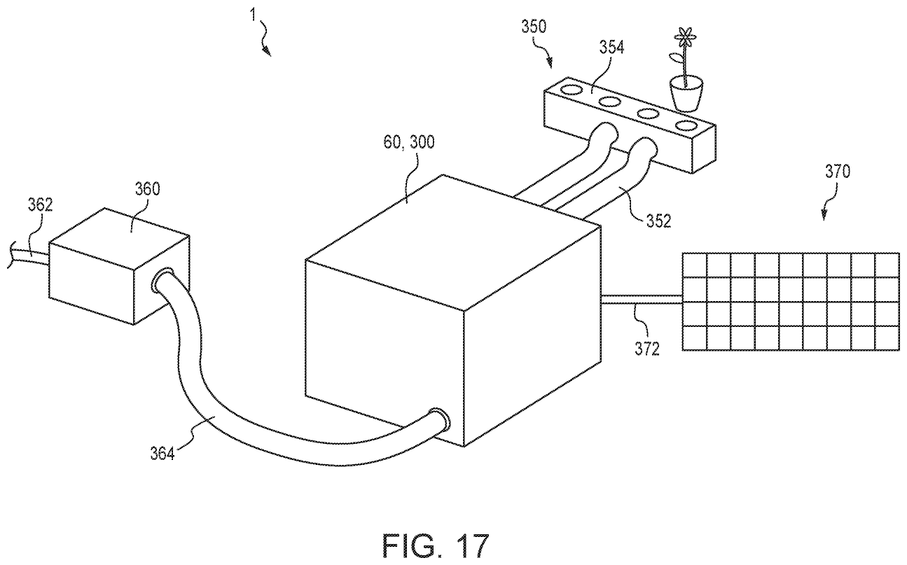

The present subject matter provides a wide array of plant growing systems. FIG. 17 illustrates an embodiment of a variant growing system as follows. The growing system includes an integrated filtering and sterilization system for both dirty water and recirculated water. This system may have particular use in remote applications where supply of fresh water is limited. FIG. 17 also illustrates an optional solar panel that provides electrical power to component(s) of the plant growing system. For example, a single 320 W solar panel is sufficient for providing power for many systems. Again, this configuration may be useful in remote applications where supply of electrical power is limited. Although remote use is contemplated, it will be understood that the growing system depicted in FIG. 17 can be used in non-remote locations. It is also contemplated that the system of FIG. 17 may include a support system and connection locations for the support system for use in training plants.

Specifically, FIG. 17 illustrates a growing system 1 including a filtering system 360, a fog production chamber such as previously described chambers 60 or 300, a fog handling system such as previously described fog handling system 350, and a solar panel 370. The filtering system 360 receives water from a water supply line 362, and can include filtering media such as charcoal, and may optionally include a nutrient/pH adjusting system. Filtered or nutrient/pH adjusted water is then directed to the fog production chamber 300 through a transfer line 364. As previously described in association with the fog production chamber 300, fog produced within the chamber 300 can be directed to a fog manifold 354 through fog conduits 352. Electrical power can be supplied to the fog production chamber 300 such as to controller(s) and/or piezo elements therein, by one or more solar panels 370. The solar panel(s) transmit electrical power or current to the fog production chamber 300 via electrical lines 372.

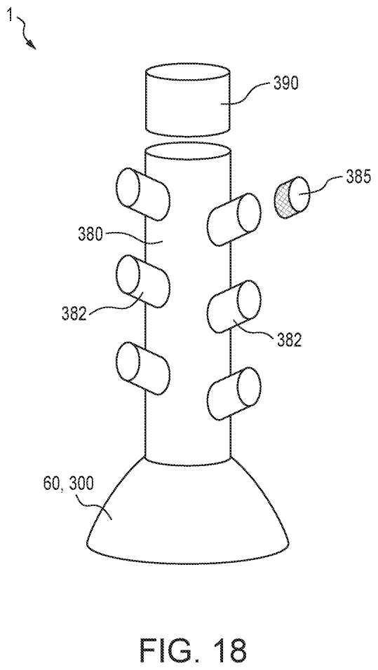

FIG. 18 illustrates another embodiment of a plant growing system in accordance with the present subject matter. The growing system may include one or more growing tubes that can be stacked or otherwise engaged with each other to readily increase available growing area. A top or uppermost tube can include one or more ceramic condensing discs to condense fog to liquid water and/or to limit ventilation of excess humidity from within the system. As will be understood, this will reduce water consumption. The plant growing system of FIG. 18 is modular and can be integrated with one or more reservoir(s) for multiple growing systems. The plant growing system typically includes one or more receiving regions for receiving net pots of various sizes. The receiving regions can be oriented at an acute angle relative to the longitudinal axis of the main component or tube. The receiving regions can be located in an ordered arrangement or in an alternating arrangement. It is also contemplated that a random arrangement or other pattern(s) could be used.

Specifically, FIG. 18 illustrates a plant growing system 1 comprising a fog chamber which can be in the form of previously described fog chambers 60, 300. Extending outward or beyond the fog production chamber is a growing tube 380. An uppermost condenser 390 is provided to condense fog within the tube 380 and return the condensed water to the fog chamber. The growing tube 380 includes one or more receiving regions 382 which are preferably in the form of tubular members extending outward from the growing tube 380. Each receiving region is preferably configured to receive and retain a plant and particularly a netted pot 385.

The present subject matter also provides various plant growing systems that utilize a communal water reservoir which feeds or supplies water to a plurality of growing units, each including an integrated receptacle and fog production chamber. In many versions, each unit includes fog production provisions as described herein, air movement devices such as fans, and control provisions such as timers that enable a user to program the fog production provisions and/or the fans to operate intermittently, or for predetermined lengths of time. In many applications it is desirable to use a day-hour-minute timer for plants harvested within a day range of from 60 to 90 days. Each unit in water supply communication with the communal water reservoir, may include a weighted bottom for increased stability. This may be desirable for relatively large plants. Each unit may also include an internal water reservoir, such as described herein, with an optional water level indicator for stand alone use. Each unit may also include control provisions that enable a user to control fog output within each unit. It is also contemplated that the control provisions may be configured to enable control of fog production in all units of the connected system. Generally, each unit includes connections for linking to the communal water reservoir. This enables the communal water reservoir to provide water to all units, and provides a redundancy in the event of a power outage.

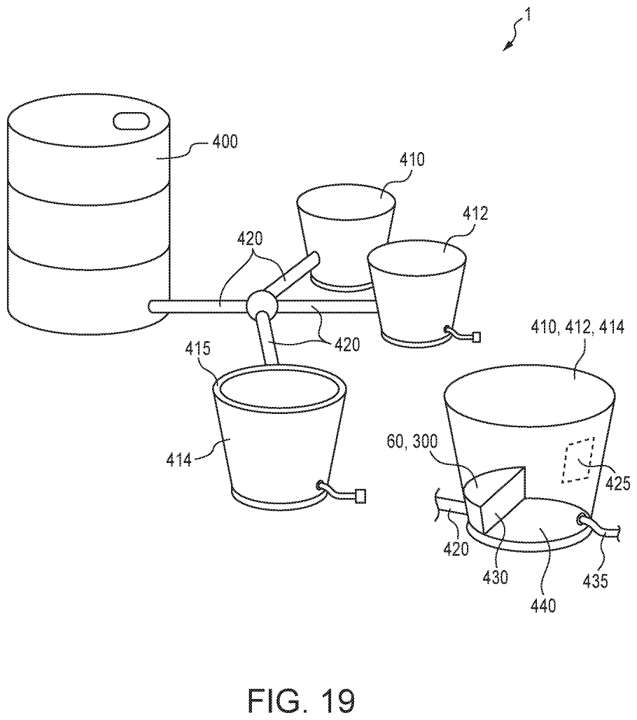

FIG. 19 illustrates an embodiment of a plant growing system including a communal water reservoir, a plurality of growing units, and water supply lines extending between each unit and the reservoir. Specifically, FIG. 19 illustrates plant growing system 1 comprising a communal water reservoir 400 which supplies water to a plurality of growing units 410, 412, and 414. Water is directed from the communal water reservoir 400 to the growing units 410, 412, 414 via water transfer lines 420. Each of the growing units 410, 412, and 414 may include fog production provisions such as chambers 60, 300; one or more fans 425; and control provisions 430. Each growing unit 410, 412, and 414 can include a weighted bottom base 440 that can be fitted with connections 435 for water drainage and/or electrical power. It is also contemplated that one or more of the growing units can include walls that are formed from material associated with net pots. Growing unit 414 is depicted with such a wall 415.

### Decorative Planters

The present subject matter also provides growing systems as described herein which are incorporated, integrated into, and/or provided in the form of decorative planters. The planters can be provided in the form of decorative pots, vases, or other products typically placed in or around residential homes and gardens. The planters may be provided in various sizes, shapes, and designs for differing applications. Each planter includes fog production provisions as described herein, and optionally with air movement devices such as fans with controllers such as timers. Each planter can also include a nutrient/pH dosing system as described herein. Each planter can also include a water reservoir with a water level indicator, along with a filling system. Each planter can include communication provisions for transmitting or providing information as to water amount or level within the water reservoir, and time until a refill is needed which as previously described can be computed based on fog output parameters. Each planter can include a weighted bottom for increased stability which may be useful for large plants. In addition, each planter may include venting provisions which may be suitable for growing plants that require relatively high humidity conditions such as orchids.

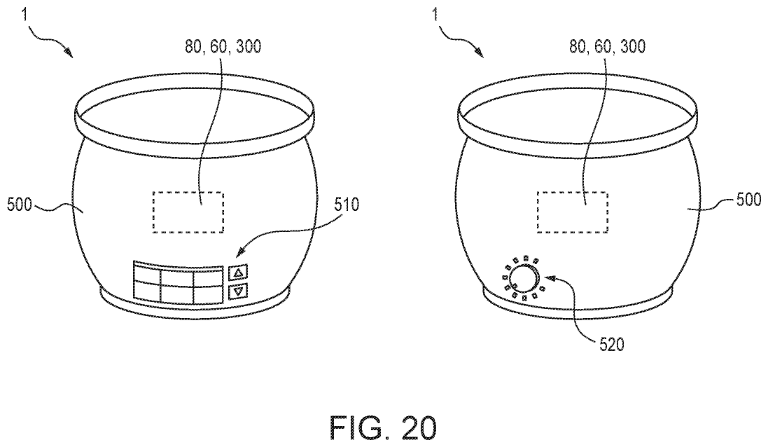

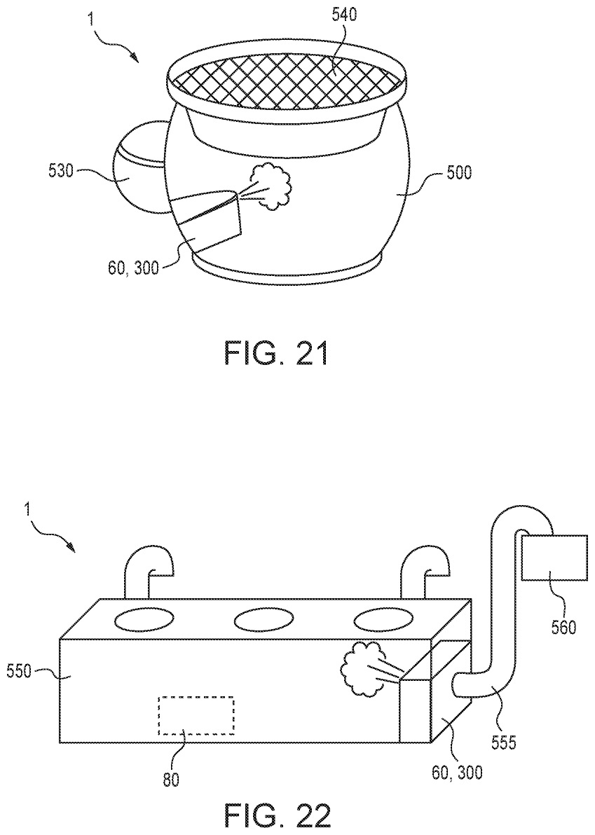

FIGS. 20-22 illustrate embodiments of a decorative planter growing system in accordance with the present subject matter. Specifically, FIG. 20 illustrates opposite sides of a decorative planter growing system 1 including a decorative outer container 500 that houses a water reservoir 80 and fog production provisions 60, 300 as previously described. The decorative planter 1 includes a multi-functional display and/or control panel 510 accessible along an exterior of the container 500. Timer controls 520 can also be provided along an exterior region of the container. FIG. 21 illustrates another embodiment of a decorative planter growing system 1 having an external water reservoir 530 detachable from a container 500. The external water reservoir 530 is configured to provide water to a fog production chamber 60, 300 located within the container 530. A lid can be positioned over an open top region of the container 500. FIG. 21 also illustrates a net pot 540 that can be placed or otherwise positioned in the container 500. FIG. 22 illustrates another embodiment of a decorative planter growing system 1 in the form of a rectangular “planter style container.” The decorative planter can include a rectangular container 550, an internal water reservoir 80, an external water reservoir 560, and/or provisions 555 to receive water from the external reservoir 560 or other water supply. The decorative planter includes one or more fog production chambers such as chambers 60, 300 located within an interior region of the planter. The decorative planters of FIGS. 20-22 can include or utilize any of the features or aspects of the present subject matter described herein. In addition, it will be noted that any of the planters can receive and/or be used with net pots which may contain growing medium and optionally also include seed(s) and/or plants.

### Networks of Multiple Plant Growing Systems

In a particular embodiment, the present subject matter provides a network or system of multiple plant growing systems. The network comprises one or more plant growing systems, a registration and control component, and optionally one or more mobile devices. These components are preferably all in data transmission with each other via cloud computing and/or the internet, as described herein. In particular applications, one or more plant growing systems are registered with the registration and control component and thus enable data collection from each plant growing system, preferably through the cloud. The registration and control component then analyzes and monitors the data and may provide information to a seller, supplier, and/or licensor, and/or to registered users and/or their growing systems as to plant growth, assessing plant health, and/or assessing operational issues for example.

The registration and control component receives information and data, retains information and data, administers access and use permissions, and governs user access to, and use of, plant growing systems registered with the system. The registration and control component in many embodiments of the present subject matter is provided by one or more computer servers or units which may be remotely located. As described herein, typically the one or more registration and control component(s) is accessed via the internet and can include cloud-based storage, processing, and/or communication. Cloud storage is a model of computer data storage, in which digital data is physically stored on multiple servers (sometimes in multiple locations), wherein the physical environment is typically owned and managed by a cloud storage provider, responsible for keeping the data available and accessible, and the physical environment protected and running.

The registration and control component of the present subject matter includes a database and data storage provisions in which user information is stored and securely retained. Non-limiting examples of retained information include authorized user name; registrant name if different from authorized user name; company or organization name; contact information of user, registrant, and/or company; date of initial registration of user and/or plant growing system(s), and plant(s), and optionally dates of subsequent registrations or logins; password(s) and other confidential information relating to a user, a registrant, and/or a company; designation or status of user, registrant, and/or company; location of registered user and/or growing system; present or predesignated growing system parameters to be monitored and their associated parameter limits; actual use-based growing system parameters that are monitored; warnings or indicators associated with registered growing systems or users; status of warnings or indicators; and other information and data including IP addresses used to register growing systems or to enable each growing system.

In select embodiments, the registration and control component may include electronic communication systems or provisions (wireless and/or cellular) for enabling the registration and control component to exchange, transmit, or receive information (such as above-mentioned data gathered during growing system operation) from the one or more mobile electronic devices. In many embodiments of the present subject matter, the registration and control component includes internet communication provisions.

In many versions of the present subject matter, the growing systems and particularly the registration and control component use cloud-based storage systems and/or cloud-based data-processing and storage systems that can be accessed and implemented in a distributed fashion using remotely located servers or other computers. Typically such servers, computers and/or other devices are accessed via the internet.

In connection with the present subject matter, cloud-based storage and/or cloud-based processing refers to online storage and/or processing by which data is stored (either virtually or actually) and/or processed across one or multiple servers, typically hosted by commercial internet service providers. In embodiments, the term “cloud-based computing” refers to one or more cloud-based data storage, cloud-based data processing, or cloud-based data communication components. Also, commercial internet service providers may include data centers, able to virtualize certain resources based on user requirements. The data storage services of such providers may be accessed via web service application programming interfaces (“API”) or via web-based user interfaces (“UI”). Cloud-based computing is described in the prior art including, e.g., WO 2013/141868; US 2012/0060165; WO 2013/119247; and US 2011/0153868.

The networked system of growing systems of the present subject matter typically also include at least one electronic-based mobile device. Non-limiting examples of such mobile devices include personal data assistants (“PDAs”), smartphones, tablet computers, laptop computers, and so forth. More particularly, a preferred mobile device for the present subject matter includes a computing device having a small-form factor portable electronic device such as a mobile phone or smartphone, or, alternatively, a personal data assistant (“PDA”), a personal media-player device, an application-specific device, such as a tablet computer or a slate computing device, or a hybrid device that may include any of the above-noted functions. Nonlimiting examples of smartphones include devices running on ANDROID or IPHONE, e.g., iOS, platforms. Nonlimiting examples of tablet computing devices include IPAD available from Apple Corporation. Nonlimiting examples of a personal media player device is an IPOD or more particularly an IPOD TOUCH available from Apple. The mobile device may also be in the form of a personal computer including both laptop computer and/or non-laptop, e.g., desktop, computer configurations.

The electronic mobile devices of the present subject matter include electronic data storage provisions, control provisions, communication provisions, user interface provision, and more. Data storage provisions of the mobile devices enable information relating to growing system use, user information, data, and permissions to access data from the registration and control component to be stored on the system and accessed at the mobile device. The data storage provisions can be in the form of known data storage formats including flash-memory components. Such data storage provisions may also include or be in the form of memory cards, disk or drive components, data cartridges or components such as ROM or RAM memory, and peripheral data-storage components.

Control provisions of the mobile devices typically include electronic circuitry, generally in the form of one or more processors. In embodiments, mobile devices may control data and/or information exchange or transmission with one or more growing systems registered with the networked system. As mentioned above, the electronic mobile devices relay activation signal(s) issued from the registration and control component to the growing system(s).

The mobile devices of the present subject matter also include communication provisions operatively effective between the mobile device and one or more growing systems; and also operatively effective between the mobile device and a registration and control component of a networked growing system. Communication between the mobile device and the growing system(s) can be established or provided using one or more communication formats such as radio frequency (“RF”), infrared (“IR”), and/or BLUETOOTH as known in the art. Specifically, the term “BLUETOOTH” relates to a wireless technology standard that is used for exchanging data between fixed and mobile devices over short distances using short-wavelength UHF radio waves via, for example, industrial, scientific and medical radio bands, of from about 2.402 to 2.480 GHz, and Personal Area Networks (“PANs”) established in certain buildings, both public and private, as well as certain other areas. In particular embodiments, wireless communication is via wireless local area network (“WLAN”), also known as, Wi-Fi. The present subject matter includes using other types of communication, e.g., near-field communications (“NFC”). And for such purposes, a nonlimiting list of suitable wireless protocols, enabling wireless communication between at least one electronic mobile device and at least one growing system(s), both of which are configured for exchanging data via wireless communication links, include ZIGBEE, GLOWPAN, Wireless HART, ISA 100, WiMi, SimpliciTI, KNX, EnOcean, Dash7, WISA, ANT, ANT+, WiMax, ONE-NET, Z-Wave, Insteon, and RuBee. A particularly preferred form of electronic communication, cellular communication, can also be used. Also, as an alternative to wireless and/or cellular communication, electronic signal transmission including transmission of data or other information, between at least one mobile device and a growing system, can also be established by cables or other hardwired connections.

Mobile devices may be communicatively coupled to cloud-based service and data centers and/or a third party entity via, e.g., at least a wireless local area network technology (WLAN), i.e., Wi-Fi. However, embodiments of local access to cloud-based storage are not limited to wireless communications, and therefore hardwired communications may also apply to the embodiments described herein.

The various electronic mobile devices of the present subject matter thus are configured to include electronic communication provisions between the at least one mobile device and the registration and control component. Typically, such electronic communications are transmitted and exchanged via the internet, and often utilize a cloud-based infrastructure. However, the present subject matter includes using other communications between a mobile device and the registration and control component.

The electronic mobile devices may also include one or more user-interface provisions. For instance, a mobile device could be in the form of a portable electronic computer, for example an IPAD. Or, another suitable electronic mobile device could include a keyboard, provided either virtually or as a physical input device incorporated into the body of a mobile device or separable from but connectable to the mobile device. Still other input components could be used such as mouses, track balls, and joysticks for example. Also, an electronic mobile device of the present subject matter typically includes a display or other information output, enabling such information to displayed for or viewed by a user. While such display is typically incorporated into the mobile device, the present subject matter contemplates using separate but connectable displays.

As previously noted, the mobile devices also include electronic data storage provisions and growing system use control provisions. In select embodiments of the present subject matter, the mobile device is configured to run or execute an algorithm or App as known in the art which facilitates communication with the registration and control component and/or the growing system. Apps, their transfer or download, and the “running” and maintenance of such “apps” are described in the prior art including U.S. Pat. No. 8,549,656; US 2013/0122861; WO 2013/163249; and WO 2012/155937. In relation to the present subject matter, the algorithm or app selected for a growing system may also facilitate administration of permissions from the registration and control component, transmission of data or information between the registration and control component and the mobile device, and/or between the registration and control component and an electronic mobile device and at least one of the growing systems of the present subject matter. The algorithm or App may also facilitate user access, use of one or more growing systems of interest, and/or provide indications and/or warnings to a user concerning the growing systems and/or the networked system.

The growing systems each include communication provisions and preferably wireless communication provisions for data and information transfer with the one or more mobile devices and/or the registration and control component, and optionally with other components or devices. The communication provisions are as described herein. The communication provisions also enable transfer of user control actions typically from mobile device(s) to the growing systems. As will be understood, the growing systems also include electronic data storage provisions, data processing provisions, and computational circuitry for operation, control, and data management of the growing system.

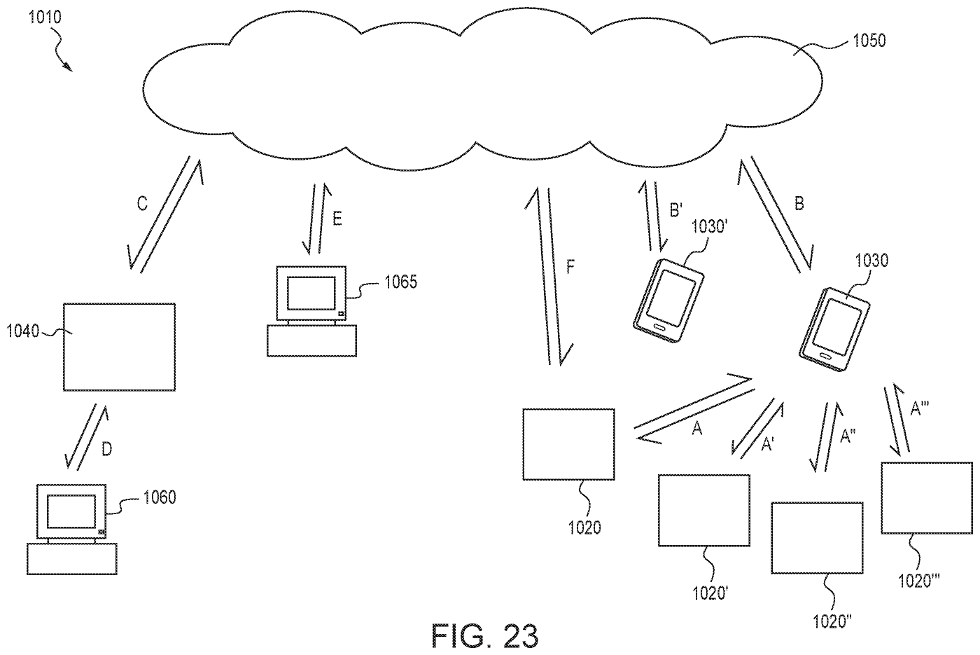

FIG. 23 schematically illustrates an embodiment of a system 1010 in accordance with the present subject matter. The system 1010 comprises one or more plant growing systems 1020, one or more mobile devices 1030, and a registration and control component 1040. In many embodiments of the present subject matter, the system 1010 also comprises a cloud-based infrastructure 1050 for providing communication between the registration and control component 1040, the one or more mobile devices 1030, and the one or more plant growing systems 1020.

The system 1010 comprises one or more communication links between the growing system(s) 1020 and the mobile device(s) 1030 collectively shown in FIG. 23 as link(s) A. More particularly, other nonlimiting examples of growing systems include a growing system 1020′ which can communicate with the mobile device 1030 via link(s) A′, another growing system 1020″ which can communicate with the mobile device 1030 via link(s) A″, and another growing system 1020″ which can communicate with the mobile device 1030 via link(s) A′″. The system 1010 also comprises one or more communication links between the mobile device(s) 1030 and the cloud-based infrastructure 1050 collectively shown in FIG. 23 as link(s) B. The system can also comprise additional mobile device(s) collectively depicted as 1030′ which can communicate with the cloud 1050 via link(s) B′. The system 1010 also comprises one or more communication links between the registration and control component 1040 and the cloud-based infrastructure 1050 collectively shown in FIG. 23 as link(s) C. It is contemplated that communication link(s) could also be provided directly between the registration and control component 1040 and the mobile device(s) 1030. In addition, the system 1010 can comprise one or more personal computers (PCs) or laptop computers 1060 which can communicate via link(s) D with the registration and control component 1040. And, the system 1010 can also comprise one or more personal computers (PCs) or laptop computers 1065 which can communicate with the cloud 1050 via link(s) E. Referring further to FIG. 23, the growing system 1020 can also communicate with the cloud-based infrastructure via link(s) F. The present subject matter also includes variations of these systems. For example, computers 1060 and/or 1065 can also be configured to communicate with the growing system(s) 1020. Thus the computers 1060, 1065 serve a role of the mobile device 1030.

A wide array of applications and additional versions of the plant growing systems are contemplated.

In one version, the plant growing system will communicate to the cloud via a connection to a phone or a computer. A seller, supplier, or licensor will provide a platform on which users can share their experience and photos of their gardening to social media. Such sellers, suppliers, or licensors will have their own social media aspect for users to share and create.

In another version, a seller, supplier, or licensor will collect op-in users data to create a better experience and compile a database of the better garden practices and provide that content to users in a variety of fashions.

In another version, a seller, supplier, or licensor will offer various analytical tools for the user to create spreadsheets and other reports to their supervisors or other personnel, or for personal use.

In another version, a seller, supplier, or licensor will set up monthly competitions for gardening goals that reward the user in various ways.

It is also contemplated that Apps may be provided that also allow the user to have direct control over all or only certain aspects of the machine. For example, if a warning comes on and indicates that there is only 2 hours of water left and a user is at a remote or distant location, the user could turn the fog output down or the timer for fog production function could be adjusted to 5 minutes on with 15 minutes off, or both.

It is also contemplated that the growing system could include presets that will take the plant through its life cycle. For example, a user is growing a tomato plant with a 65 day growing period. The system will dictate the temperature, humidity at certain zones, light spectrum and intensity, nutrient and pH level, and these will change slightly every day to maximize plant growth within each stages. This strategy may first result from historic data and testing but will evolve with users op-in data so the method can be extremely specific as well as provide better controllability being offered by new technology such as LED lighting.

In still further versions, different lids will be available. One lid will allow room for various hydroponic growing medium. Another lid may be provided for using in association with a proprietary woven mat, and that is optionally pre-seeded. These will have different support structures such as many small holes or a lattice type structure to allow maximum root exposure. The lids may have varying depths to allow many mats to be placed one on top of another.

Additionally, new lids may be provided that will have different hole sizes to hold net pots filled with a hydroponic medium of the users choice. These lids may or may not be specific to the type of plant grown to provide support systems, when needed, for that type of plant. For example, lettuce lids will not have supports and have enough space between openings to not over crowd plant growth. Tomatoes, and like plants, will need supports to hold up the heavy fruits and have a different hole spacing to provide more medium, less horizontal space and more vertical space.

Furthermore, the growing system may also be used with a biodegradable collar/plug for propagation of cuttings or seeds. Such a collar or plug could be formed from a coconut coir fiber weave that is covered with plastic on the top and sides to promote fog retention. Other materials may potentially be used to add functionality such as willow bark that has natural rooting hormones. Or, materials may be soaked in a rooting solution so the user is not required to add such to the plant topically when taking the cutting or watering in the seed.

In addition, regarding interchangeable covers, some units may be outfitted with connection locations for a veneer type of outer cover. This will allow the user to change the look of their units as desired. Many different designs can be provided from traditional styles such as terra cotta or wood to modern colors and patterns, for example, spray painted, bamboo, art deco, vintage, nature photo, etc.

Moreover, various levels of filtration and self cleaning will be added to deluxe models and those made for off grid or remote applications. As water is recirculated or introduced it will pass through a sediment or carbon filter for particulate matter to a UV filter for biological filtration. This process may be in the reverse order depending on data or other parameter(s).

It is also contemplated that self cleaning may be performed by various methods such as, a small arm that cleans the piezo elements, a higher functioning assembly that is able to self clean via increased frequency or rapid on-off function.

Furthermore, it is contemplated that a replaceable piezo element similar to a cartridge that can be removed and replaced with new piezo element. This would enable the former or old piezo element to be cleaned manually.

Additionally, it is contemplated that a refillable nutrient/pH container that is connected to the outside of the unit could be used. This could be a drip type application or it could be drawn in with new water via suction. An electroconductivity (EC) and/or pH meter could be added and this would enable operation of the dosing system depending on measured needs. This information would be stored for later analysis.

### Methods

The present subject matter also provides various methods associated with the growing systems and aspects described herein. In one embodiment, a method for improving or optimizing growth of plants and/or seeds is provided.

Generally, a user will purchase the growing system with preset data points for optimal settings for generalized plant families based on research from the seller, supplier, or licensor. The user can then use the information provided or they can manipulate the settings to those that they wish or need, for example location, i.e., desert versus coastal for humidity, and/or high latitude versus equatorial for temperature. The user will utilize a data collect button or other input device for data collection when a point of growth is achieved. This can be accomplished via a physical control as well as using a mobile App. The seller, supplier, or licensor will then provide analytical tools and may optionally create reports to help the user optimize their system and methods for each plant species recorded.

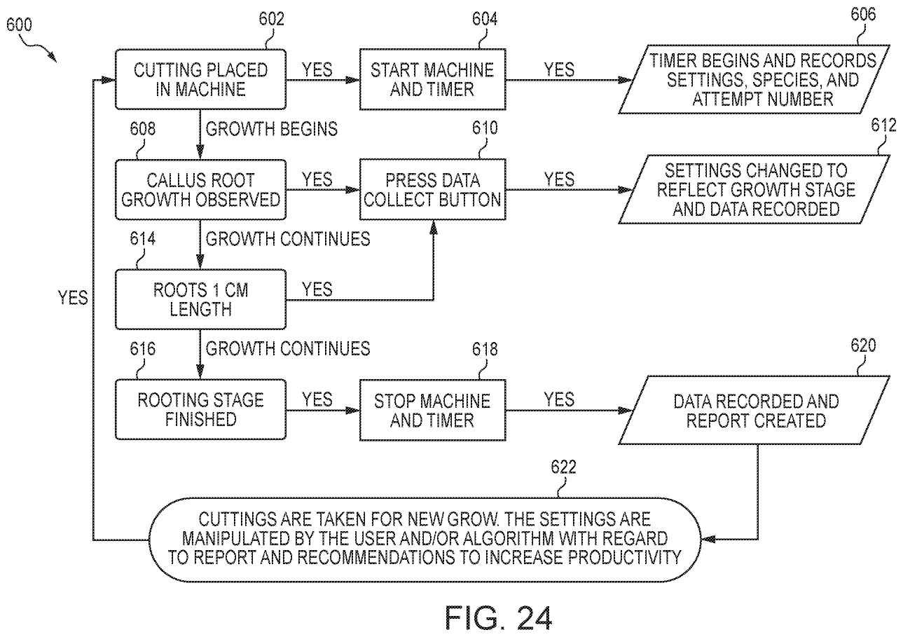

FIG. 24 is a flowchart of a representative method 600 for improving plant growth from cuttings using a growing system as described herein. Referring to FIG. 24, propagation begins and user starts clock and fog production, records species and attempt number. Settings are recorded and a timer starts running. Specifically, in operation 602, cuttings or other plant growth are placed into a growing system. In operation 604, the user starts the growing system and starts a timer. These operations lead to operation 606.

In operations 608 and 610, the user presses a button or other input device when callous root growth is observed. In operation 610, data is collected on time frame and settings. Settings are changed to reflect the change in growth stage as recommended or desired. These operations lead to operation 612.

As growth continues, the user presses a button or other input device when roots are a certain length such as 1 cm long, data is again collected on time frame and settings. These operations are shown as 614, 510. Settings again are manipulated and recorded in operation 612.

When rooting is completed, the clock and fog production are stopped, data is collected and a report is created outlining the settings used and productivity at each stage. This is compared against the seller, supplier, or licensor profile for this species as well as the users saved data on previous attempts with the same species. These operations are depicted as 616, 618, and 620 in FIG. 24.

The seller, supplier, or licensor will analyze these differences and then suggest changes to be made for future propagation at each growth stage. This will lead users and/or the seller, supplier, or licensor through the above process on each attempt so the user can achieve optimal results. Every time the user changes any setting the method can optionally provide or offer reports on how this has helped or hindered their production. This is shown as operation 622.

The seller, supplier, or licensor will also collect this data from users who opt-in to an anonymous program via the cloud and use all the collected data to help the seller, supplier, or licensor create better plant propagation profiles.

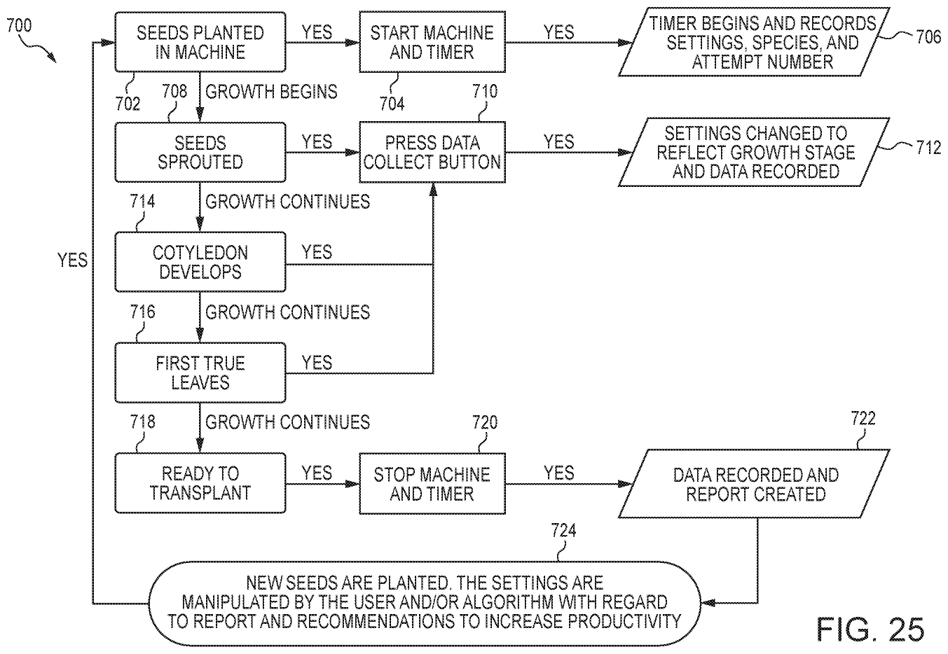

FIG. 25 is a flowchart of an embodiment of a method 700 for improving seed growth. Specifically, in operation 702 seeds are planted in a growing system as described herein. In operation 704, the machine is started and a timer is started. In operation 706, the timer and machine records settings, species, and attempt number.

Eventually seeds sprout which is shown as operation 708. At that time of observation, a user collects data in operation 710. Settings of the growing system are changed in operation 712 to reflect growth stage and data recorded.

Growth continues in operation 714. Typically, this is a Cotyledon development stage.

Growth continues in operation 716 during which the first true leaves are formed.

During and/or after operations 714, 716 the user can continue to collect data such as shown in operation 710.

In operation 718, growth continues until the plant is ready to transplant. At that time, and in operation 720, the growing system is stopped and the timer is stopped. In operation 722, data is recorded and an optional report is created.

In operation 724, the method 700 can be modified and reiterated. New seeds are planted and settings of the growing system can be manipulated by the user and/or by an algorithm with regard to reporting and recommendations for increasing productivity.

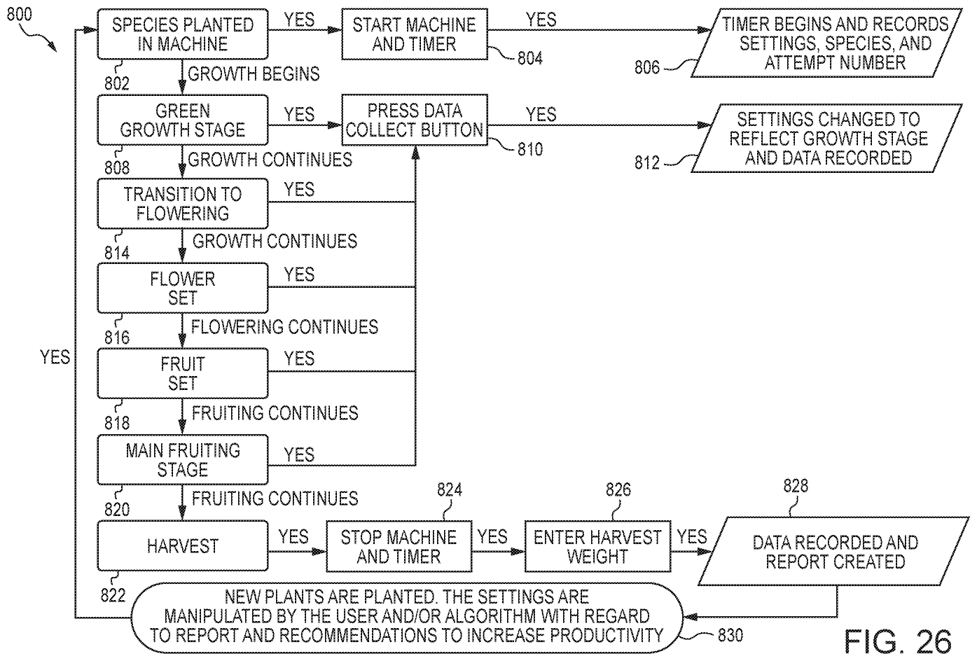

FIG. 26 is a flowchart of an embodiment of method 800 for improving species growth. Specifically, in operation 802, a species is planted in a growing system. In operation 804, the system and a timer are started. In operation 806, the timer begins and the growing system records settings, species, and attempt number.

Growth begins and in operation 808 a green growth stage occurs. A user may press a data collect button or other input device in operation 810. In operation 812, settings of the growth system are changed to reflect the growth stage and data is recorded.

In operation 814, growth continues and the plant transitions to flowering. A user may press a data collect button or other input device in operation 812, and settings of the growth system are changed to reflect the growth stage and data is recorded.

In operation 816, growth continues to a flower set. A user may press a data collect button in operation 812, and settings of the growth system are changed to reflect the growth stage and data is recorded.

In operation 818, growth continues to a fruit set. A user may press a data collect button in operation 812, and settings of the growth system are changed to reflect the growth stage and data is recorded.

In operation 820, growth continues to a main fruiting stage. A user may press a data collect button in operation 812, and settings of the growth system are changed to reflect the growth stage and data is recorded.

Fruiting continues and in operation 822, harvest may occur. If so, the user stops the growing system and timer in operation 824. In operation 826, the user enters the harvest weight into the growing system. In operation 828, data is recorded and an optional report is created.

In operation 830, the method 800 can be modified and reiterated. New plants are planted and settings of the growing system can be manipulated by the user and/or by an algorithm with regard to reporting and recommendations for increasing productivity.

The method(s) can be specifically tailored to individual plant types. For example, set forth below in Tables 1, 2, and 3 are representative growth system pre-settings for three different types of plants.

TABLE 1
Representative Pre-Settings for Basil

Fog Production ml/min = Propagation 4~growth 2-3
Temp C. = Propagation 20-25~Growth 18-30
Light intensity Micromole = 50-250 μmol m⁻² s⁻¹
Light spectrum nm = 400-500 Mixed with 650-750 Add 1% 800-1000
Nutrient Levels Electrical Conductivity = 1.0-1.6
PH = 5.5-6.5

TABLE 2
Representative Pre-Settings for Tomato

Fog Production ml/min = Propagation 4~Growth/Fruit 2-3
Temp C. = Propagation 20-30~Growth/Fruit: Night 13-16, Day 22-26
Light intensity Micromole = 400-500 μmol m⁻² s⁻¹
Light spectrum nm = 400-500 Early Growth~475-575 Transition~500-700
Fruit
Nutrient Levels Electrical Conductivity = 2.0-5.0
PH = 5.5-6.5

TABLE 3
Representative Pre-Settings for Lettuce

Fog Production ml/min = Propagation 4~2-3 Growth
Temp C. = Propagation 13-21~Growth 15-22
Light intensity Micromole = 100-200 μmol m⁻² s⁻¹
Light spectrum nm = 400-500 Mixed with 600-700
Nutrient Levels Electrical Conductivity = 1.4
PH = 6-7

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A plant propagator system comprising:
a rack unit; and
a plurality of modular plant propagators;
wherein the rack unit includes a support frame defining a plurality of receiving regions, each receiving region configured to receive a modular plant propagator;
wherein each of the plurality of modular plant propagators is configured to fit within a corresponding receiving region, and includes (i) a receptacle, and (ii) at least one fog production chamber in flow communication with the receptacle.

2. The plant propagator system of claim 1 further comprising:
at least one assembly for slidingly engaging a modular plant propagator with the rack unit.

3. The plant propagator system of claim 1 further comprising:
a water distribution system including a water supply line extending from the rack unit and configured for connecting to a water source, and a water distribution manifold extending from the water supply line to at least one receiving region defined in the rack unit for receiving a modular plant propagator.

4. The plant propagator system of claim 1 further comprising:
at least one lighting unit disposed in the rack unit generally above a receiving region defined in the rack unit, and oriented to direct light toward a modular plant propagator received in a receiving region of the rack unit.

5. The plant propagator system of claim 1 further comprising:
at least one fan disposed in the rack unit and positioned to direct air flow between modular plant propagators received in the receiving regions of the rack unit.

6. The plant propagator system of claim 1 further comprising:
at least one condenser for condensing water vapor or humidity within the rack unit, to liquid water.

7. The plant propagator system of claim 1 further comprising at least one sensor selected from the group consisting of humidity sensors, temperature sensors, light sensors, fog or water vapor sensors, timers, ventilation sensors, and combinations thereof.

8. The plant propagator system of claim 1 further comprising:
an electrical power management system including a power supply cord extending from the rack unit and configured for connecting to an electrical power source, and an electrical power distribution member extending from the power supply cord to at least one receiving region defined in the rack unit for receiving a modular plant propagator.

9. The plant propagator system of claim 1 further comprising:
a water filtration system.

10. The plant propagator system of claim 9 wherein the water filtration system includes a nutrient delivery system.

11. A networked system of plant growing systems, the networked system comprising:
a registration and control component having data storage provisions and communication provisions;
at least one mobile electronic device including data storage provisions, communication provisions, and user interface provisions;
at least one plant growing system including a receptacle, fog production provisions, and communication provisions, the at least one plant growing system capable of communicating with the registration and control component and/or the at least one mobile electronic device.

12. The networked system of claim 11, wherein the mobile device is a smartphone.

13. The networked system of claim 11, wherein communication between the mobile device and the registration and control component is via the internet.

14. The networked system of claim 13, wherein the communication between the mobile device and the registration and control component includes cloud-based infrastructure.

15. The networked system of claim 11 wherein the at least one plant growing system further includes:
a piezo-electric element disposed in the fog production chamber, the piezo-electric element configured to generate water droplets from water in the chamber upon application of electric power to the piezo-electric element.

16. The networked system of claim 11, wherein the at least one plant growing system further includes:
a tray sized and shaped to be positioned with the receptacle, the tray defining an underside and an oppositely directed topside, the tray further defining a plurality of openings extending between the underside and the top side.
